(19) United States
(12) Patent Application Publication
(10) Pub. No.: US 2023/0329975 A1
(43) Pub. Date: Oct. 19, 2023

(54) DRUG SUPPLY DEVICE

(71) Applicant: Takazono Corporation, Kadoma-shi, Osaka (JP)

(72) Inventors: Masashi Kitani, Kadoma-shi, Osaka (JP); Yasuyuki Morikawa, Kadoma-shi, Osaka (JP); Shinya Okuda, Kadoma-shi, Osaka (JP); Hirofumi Wada, Kadoma-shi, Osaka (JP); Saki Fujii, Kadoma-shi, Osaka (JP); Akihito Isaka, Kadoma-shi, Osaka (JP); Eiichi Taniguchi, Kadoma-shi, Osaka (JP); Katsuyoshi Sakaguchi, Kadoma-shi, Osaka (JP)

(73) Assignee: Takazono Corporation, Kadoma-shi, Osaka (JP)

(21) Appl. No.: 18/025,314

(22) PCT Filed: Aug. 30, 2021
(86) PCT No.: PCT/JP2021/031709

§ 371 Date: Mar. 8, 2023

(30) Foreign Application Priority Data
Oct. 26, 2020 (JP) 2020-179025
Oct. 26, 2020 (JP) 2020-179026

(51) Int. Cl. A61J 7/00

(52) U.S. Cl. CPC A61J 7/0076; A61J 2205/60

(57) ABSTRACT

A plurality of cassettes are each allowed to supply drug within a certain range of dimensions. A plurality of drivers are each mountable with each of the cassettes and drive the cassettes mounted thereto. The controller controls the drivers individually. The controller allocates drug information of a target drug to the cassette selected in accordance with dimensions of the target drug or to the driver mounted with the cassette thus selected. The controller controls the drivers so that the target drug is supplied from the cassette to which the drug information has been allocated or the driver mounted with the cassette to which the drug information has been allocated.

### TECHNICAL FIELD

This invention relates to a drug supply device.

### BACKGROUND ART

International Publication, WO 2014/112221 (PTL 1), is a prior literature that discloses structural features of a drug delivery device. The drug delivery device described in PTL 1 is equipped with a plurality of drug-containable cassettes, an allocating means, and a drive controller. The drug-containable cassettes are allowed to optionally deliver different types of tablets. The allocating means, in response to receipt of information input concerning a target drug to be delivered, allocates the relevant drug information to a corresponding one of the drug-containable cassettes. The drive controller drives the drug-containable cassettes to operate under a preset drive condition based on the drug information allocated by the allocating means and thereby prompts the discharge of drug from these cassettes.

### CITATION LIST

### Patent Literature

PTL 1: WO 2014/112221

### SUMMARY OF INVENTION

### Technical Problem

A drug supply device should desirably be configurable in a simplified manner, so that pieces of drugs can be readily divided and packaged as prescribed.

### Solution to Problem

A drug supply device according to a first aspect of this invention includes a plurality of cassettes, a plurality of drivers, and a controller. The cassettes are capable of supplying drug within a certain range of dimensions. The drivers are each mountable with each of the cassettes and drive the cassettes mounted thereto. The controller controls the drivers individually. The controller allocates drug information of a target drug to the cassette selected in accordance with dimensions of the target drug or the driver mounted with the cassette thus selected. The controller controls the drivers so that the target drug is supplied from the cassette to which the drug information has been allocated or from the cassette mounted to the driver to which the drug information has been allocated.

In an embodiment of this invention, the drug supply device further includes a manual drug supply cassette. The controller is capable of accepting an operation that is input for selecting which of the cassette and the manual drug supply cassette supplies the target drug.

In an embodiment of this invention, the controller does not accept an operation that is input for selecting drug supply from the cassettes in an event that none of the drivers is mountable with the cassettes.

In an embodiment of this invention, the controller does not accept the operation that is input for supply, from the cassette, of drug that can be supplied from none of the cassettes.

In an embodiment of this invention, the drug supply device further includes a displayer that is capable of displaying information concerning allocation of the drug information.

In an embodiment of this invention, the controller causes the displayer to display the driver to which the cassette is mountable and the driver to which the cassette is not mountable in a distinguishable manner.

In an embodiment of this invention, the controller causes the displayer to display the drug that can be supplied from the cassette and the drug that cannot be supplied from the cassette in a distinguishable manner.

In an embodiment of this invention, the controller causes the displayer to display a history of use of the cassettes.

In an embodiment of this invention, the controller causes the displayer to display identification information of the cassette that most recently supplied the target drug.

In an embodiment of this invention, the controller causes the displayer to display a required number of tablets of the target drug for refill.

In an embodiment of this invention, the controller causes the displayer to display a shortfall of the target drug in an event of shortage of the target drug.

In an embodiment of this invention, the drug supply device further includes a reader that reads an identification code appended to a drug holder of the target drug. The controller checks the drug information against a result read and obtained by the reader.

In an embodiment of this invention, the controller allocates the drug information to the driver when the cassette selected in accordance with dimensions of the target drug is mounted to this driver.

A drug supply device according to a second aspect of this invention includes a plurality of drug suppliers and a controller. The drug suppliers are capable of supplying drug within a certain range of dimensions. The controller allocates drug information of a target drug to the drug supplier selected in accordance with dimensions of the target drug. The controller controls the drug suppliers so that the target drug is supplied from the drug supplier to which the drug information has been allocated.

A drug supply device according to a third aspect of this invention includes a plurality of cassettes, a cassette selecting tool, a plurality of drivers, and a controller. The cassettes are capable of supplying drug within a certain range of dimensions. The cassette selecting tool is capable of selecting, from the cassettes, the cassette that can supply the drug in accordance with dimensions of the drug. The drivers are each mountable with each of the cassettes and drive the cassettes mounted thereto. The controller controls the drivers individually. The controller allocates the drug information to the cassette selected by the cassette selecting tool or to the driver mounted with the cassette thus selected. The controller controls the drivers so that the drug is supplied from the cassette to which the drug information has been allocated or from the cassette mounted to the driver to which the drug information has been allocated.

In an embodiment of this invention, the cassette selecting tool includes an indication of a relationship of association between the dimensions of the drugs and the cassettes.

In an embodiment of this invention, the cassette selecting tool includes an indication of a relationship of association among dimensions of the drug, shapes of the drug, and the cassettes.

In an embodiment of this invention, the dimensions of the drug indicated correspondingly to the cassettes on the cassette selecting tool include a diameter and a thickness of the drug.

In an embodiment of this invention, the cassette selecting tool has a plurality of through holes each having a circular shape that differ in diameter from each other. When the drug is fitted into one after another of these through holes in the order of smaller to larger diameters, the drug is determinable as having a diameter within a certain range of dimensions based on the diameter of one of the through holes which the drug is first permitted to pass through.

In an embodiment of this invention, the cassette selecting tool includes a plurality of through holes each having a rectangular shape that differ in width from each other. When the drug is fitted into one after another of the through holes in the order of smaller to larger widths, the drug is determinable as having a thickness within a certain range of dimensions based on the width of one of the through holes which the drug is first permitted to pass through.

In an embodiment of this invention, the cassette selecting tool includes an indication of a certain range of dimensions of the drug for each one of the through holes.

The cassette selecting tool of this invention is capable of selecting, from the cassettes, the cassette allowed to supply the drug in accordance with dimensions of the drug.

A drug allocating device of this invention includes a plurality of cassettes, a cassette selecting tool, and a controller. The cassettes are capable of supplying drug within a certain range of dimensions. The cassette selecting tool is capable of selecting, from the cassettes, the cassette that can supply the drug in accordance with dimensions of the drug. The controller allocates the drug information to the cassette selected by the cassette selecting tool.

### Advantageous Effects of Invention

According to this invention, the drug supply device may be configurable in a simplified manner, so that any drug can be readily divided and packaged as prescribed.

### BRIEF DESCRIPTION OF DRAWINGS

FIG. 1 is a block diagram in front view that illustrates an external appearance of a drug split-packaging apparatus including a drug supply device according to an embodiment of this invention.

FIG. 2 is a perspective view of a cassette, with its cover being opened, in the drug supply device according to an embodiment of this invention.

FIG. 3 is a plan view of the cassette illustrated in FIG. 2 in a direction along an arrow III.

FIG. 4 is a bottom view of the cassette illustrated in FIG. 2 in a direction along an arrow IV.

FIG. 5 is a partially broken, perspective view of a drug container in the cassette of the drug supply device according to an embodiment of this invention.

FIG. 6 is a transparent plan view of a rotor in the cassette of the drug supply device according to an embodiment of this invention.

FIG. 7 is a lateral view of the rotor and a partitioning portion, illustrating a positional relationship therebetween, in the cassette of the drug supply device according to an embodiment of this invention.

FIG. 8 is perspective view that illustrates an external appearance of the partitioning portion in the cassette of the drug supply device according to an embodiment of this invention.

FIG. 9 is a perspective view of the partitioning portion that has been removed, as well as a partial circumferential wall, from the drug container in the cassette of the drug supply device according to an embodiment of this invention.

FIG. 10 is a cross-sectional view in a direction along an X-X line of the rotor and a drive shaft illustrated in FIG. 7.

FIG. 11 is an exploded perspective view of the rotor, cap member and drive shaft in the cassette of the drug supply device according to an embodiment of this invention.

FIG. 12 is perspective view that illustrates an external appearance of the cap member in the cassette of the drug supply device according to an embodiment of this invention.

FIG. 13 is a perspective view that illustrates how the rotor is attachable and detachable to and from the drive shaft in the cassette of the drug supply device according to an embodiment of this invention.

FIG. 14 is a perspective view that illustrates the cassette, before cleaning starts, of the drug supply device according to an embodiment of this invention after the partitioning portion, as well as the partial circumferential wall, is removed from the drug container and the rotor is then removed from the drive shaft.

FIG. 15 is a lateral view that illustrates the cassette closed with a cover, after the cleaning ends, of the drug supply device according to an embodiment of this invention after the rotor is attached to the drive shaft and the partitioning portion, as well as the partial circumferential wall, is then put back into the drug container.

FIG. 16 is a block diagram that illustrates connections in the drug split-packaging apparatus including the drug supply device according to an embodiment of this invention.

FIG. 17 is a block diagram that illustrates operational steps in the drug split-packaging apparatus including the drug supply device according to an embodiment of this invention.

FIG. 18 is a drawing that illustrates an initial display of a prescription screen displayed on an operation panel of the drug supply device according to an embodiment of this invention.

FIG. 19 is a drawing that illustrates a selection screen displayed on the operation panel of the drug supply device according to an embodiment of this invention.

FIG. 20 is a drawing that illustrates a refill instructing screen displayed on the operation panel of the drug supply device according to an embodiment of this invention.

FIG. 21 is a drawing that illustrates a manual supply instructing screen displayed on the operation panel of the drug supply device according to an embodiment of this invention.

FIG. 22 is a drawing that illustrates a cassette use history screen displayed on the operation panel of the drug supply device according to an embodiment of this invention.

FIG. 23 is a drawing that illustrates the refill instructing screen displayed for drug shortage on the operation panel of the drug supply device according to an embodiment of this invention.

FIG. 24 is a drawing that illustrates the refill instructing screen displayed on the operation panel in which prior checking has been set before an identification code is read by a reader.

FIG. 25 is a drawing that illustrates the refill instructing screen displayed on the operation panel of the drug supply device according to the embodiment of this invention when any cassette is waiting to be cleaned.

FIG. 26 is a drawing that illustrates the refill instructing screen displayed on the operation panel of the drug supply device according to the embodiment of this invention for trouble at any cassette position.

FIG. 27 is a plan view that illustrates a cassette selecting tool in the drug supply device according to an embodiment of this invention,

FIG. 28 is a flow chart of operational steps for drug supply from a cassette selected in accordance with dimensions of the drug in the drug supply device according to an embodiment of this invention.

### DESCRIPTION OF EMBODIMENTS

A drug supply device, a cassette selecting tool, and a drug allocating device according to an embodiment of this invention are hereinafter described with reference to the accompanying drawings. In the description of embodiments given below, the same or similar components and devices are simply illustrated with the same reference signs, redundant description of which will basically be omitted. The description is hereinafter given to a drug split-packaging apparatus equipped with a drug supply device according to an embodiment of this invention. The drug supply device constitutes a part of the drug split-packaging apparatus and includes the components and devices of the drug split-packaging apparatus described later except a packaging device. The cassette selecting tool and the drug allocating device both constitute a part of the drug supply device.

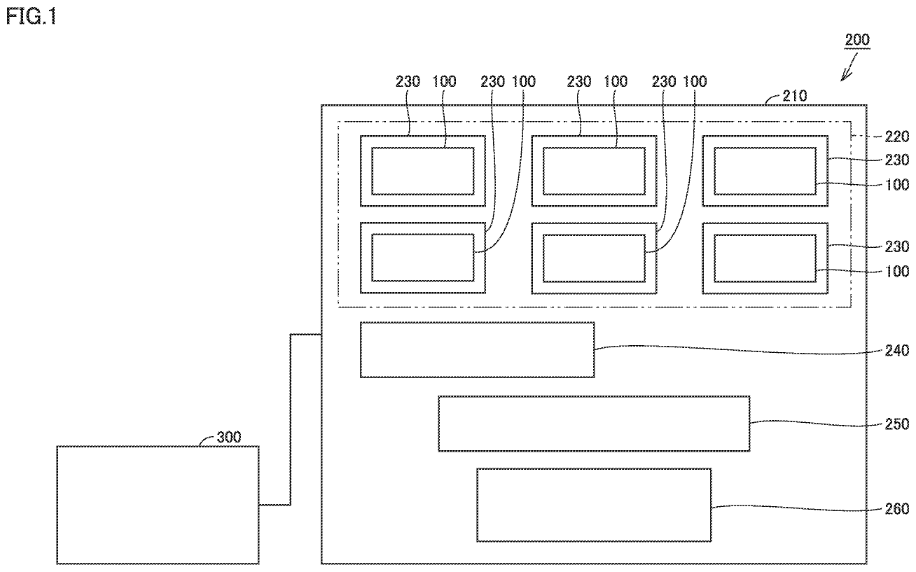

FIG. 1 is a block diagram in front view that illustrates an external appearance of a drug split-packaging apparatus including a drug supply device according to an embodiment of this invention. As illustrated in FIG. 1, a drug split-packaging apparatus 200 including the drug supply device according to one embodiment of this invention is equipped with a cabinet 210, a tablet supplier 220, and a packaging device 260. Drug split-packaging apparatus 200 further includes a manual drug supply cassette 240, a powdered drug supplier 250, and a control device 300. Tablet supplier 220, manual drug supply cassette 240, powdered drug supplier 250, and packaging device 260 are housed in cabinet 210. The drug supply device has cabinet 210, tablet supplier 220, manual drug supply cassette 240, powdered drug supplier 250 and control device 300.

Tablet supplier 220 has a plurality of cassette positions 230 for placement of cassettes 100. The cassette positions 230 are arranged in a matrix form in cabinet 210. In this embodiment, tablet supplier 220 has six cassette positions 230. One cassette 100 is disposed at each of six cassette positions 230. Thus, tablet supplier 220 can be loaded with six cassettes 100.

At each of cassette positions 230 are also disposed a driver that drives cassette 100 and a RFID (Radio Frequency Identification) reader/writer.

Manual drug supply cassette 240 has compartments arranged in a matrix form. Each compartment contains drug for one pouch. Powdered drug supplier 250 supplies drug in powdered form. Packaging device 260 receives a target drug from each of tablet supplier 220, manual drug supply cassette 240 and powdered drug supplier 250 and then packages the received drug per pouch. Control device 300 controls tablet supplier 220, manual drug supply cassette 240, powdered drug supplier 250, and packaging device 260.

Next, a cassette; an example of the drug supplier, of the drug supply device according to an embodiment of this invention is hereinafter described with reference to the accompanying drawings.

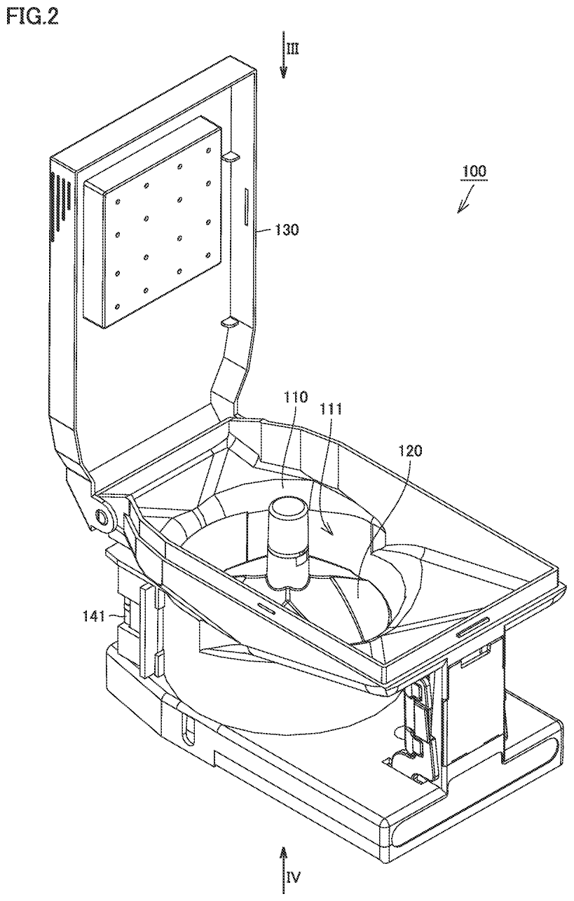

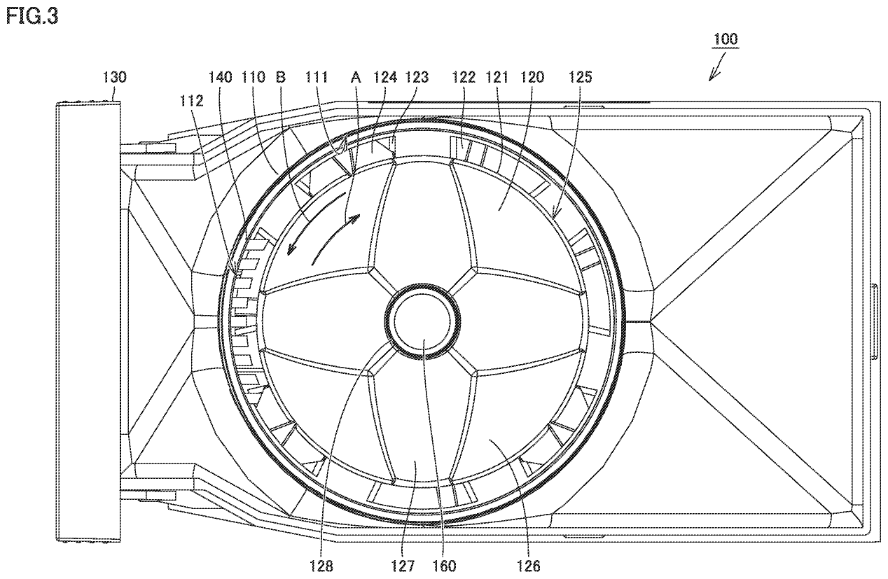

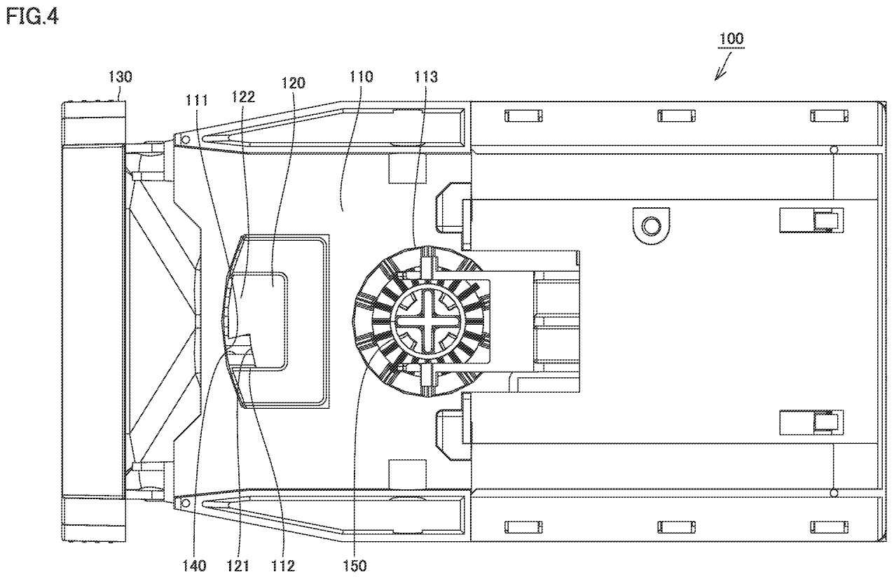

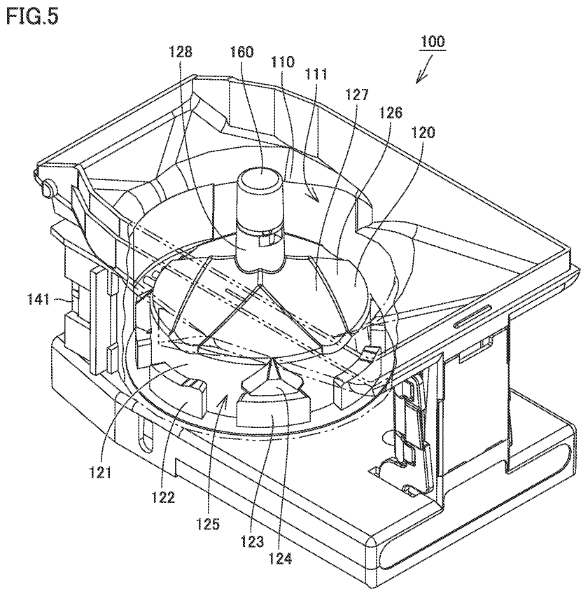

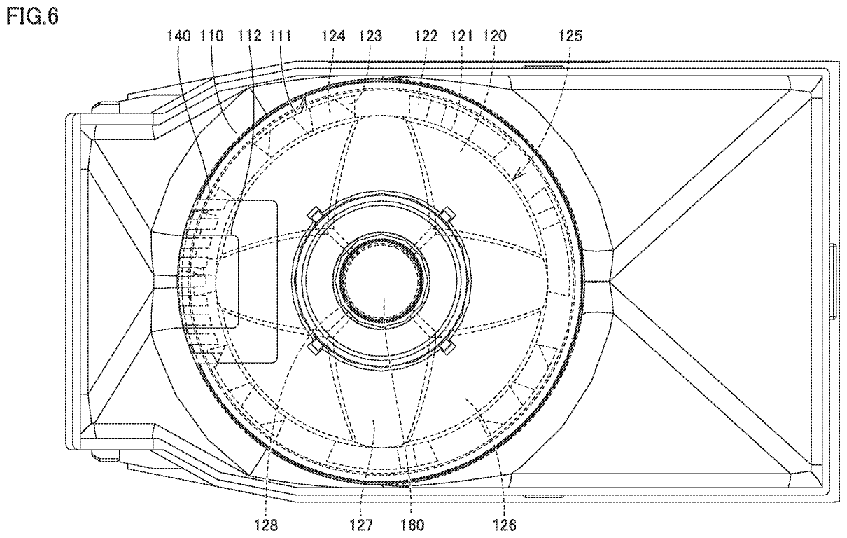

FIG. 2 is a perspective view of a cassette, with its cover being opened, in the drug supply device according to an embodiment of this invention. FIG. 3 is a plan view of the cassette illustrated in FIG. 2 in a direction along an arrow III. FIG. 4 is a bottom view of the cassette illustrated in FIG. 2 in a direction along an arrow IV. FIG. 5 is a partially broken, perspective view of a drug container in the cassette of the drug supply device according to an embodiment of this invention. FIG. 6 is a transparent plan view of a rotor in the cassette of the drug supply device according to an embodiment of this invention. In FIGS. 5 and 6 are illustrated the cassette after its cover is removed. In FIG. 6, the rotor is illustrated with a dotted line.

As illustrated in FIGS. 2 to 4, cassettes 100 of the drug supply device according to an embodiment of this invention each have a drug container 110, a rotor 120 and a drive shaft 150. Cassette 100 further has a cover 130 and a partitioning portion 140.

Drug container 110 has a circumferential wall 111 and an outlet 112. This drug container 110 contains drug on the inner side of circumferential wall 111 and discharges the drug out of the container through outlet 112. Circumferential wall 111 has a cylindrical inner surface. Outlet 112 is formed in the bottom surface of drug container 110. This outlet is adjacent to the inner surface of circumferential wall 111 on the radially inner side of circumferential wall 111.

As illustrated in FIG. 4, cassette 100 has a circular opening 113 formed in the bottom surface of drug container 110 at a position on the center axis of circumferential wall 111. Through opening 113 is inserted drive shaft 150 which is connected to a motor that rotates rotor 120 not illustrated in the drawings. Drive shaft 150 is coaxial with rotor 120 and is rotatably secured to the inner side of circumferential wall 111. Thus, drive shaft 150 is rotatably secured to drug container 110. Rotor 120 is axially mounted removably to drive shaft 150 and is rotated by this drive shaft. Rotor 120 and drive shaft 150 are both formed using a resin material.

As illustrated in FIG. 2, cover 130 is rotatably attached to drug container 110 to open and close this drug container.

As illustrated in FIGS. 2 to 6, rotor 120 is installed in the interior of drug container 110 and is rotated to transport the drug out of drug container 110 toward outlet 112. Rotor 120 is disposed on the bottom surface of drug container 110 on the inner side of circumferential wall 111. In this embodiment, rotor 120 is rotatable in two directions; forward toward one side in the circumferential direction of rotor 120, as illustrated with an arrow A in FIG. 3, and also backward toward the other side in the circumferential direction of rotor 120, as illustrated with an arrow B in FIG. 3. Rotor 120 may not necessarily be rotatable both forward and backward, insofar as this rotor 120 is at least rotatable toward circumferentially one side.

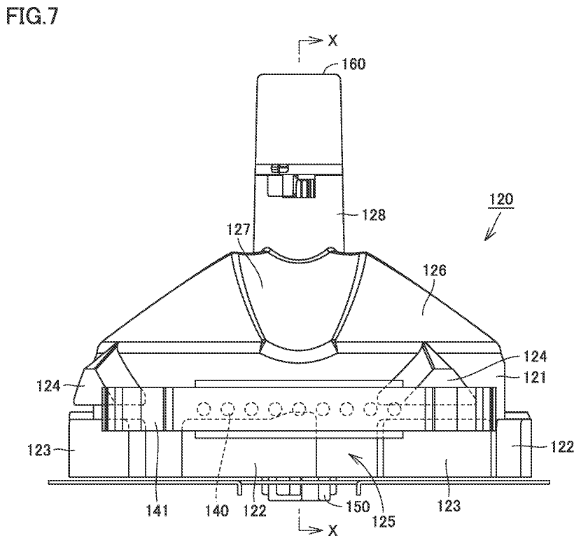

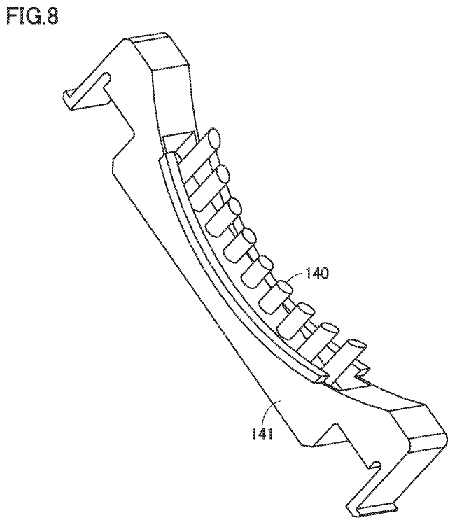

FIG. 7 is a lateral view of the rotor and the partitioning portion, illustrating a positional relationship therebetween, in the cassette of the drug supply device according to an embodiment of this invention. FIG. 8 is perspective view that illustrates an external appearance of the partitioning portion in the cassette of the drug supply device according to an embodiment of this invention. FIG. 7 illustrates rotor 120 that has been mounted to drive shaft 150.

As illustrated in FIGS. 3 and 5 to 7, rotor 120 has an inclined top surface 126 bulging upward and a circumferential surface 121 adjacent to top surface 126. Top surface 126 has a plurality of grooves 127 that are radially formed. A columnar central protrusion 128 is formed in a manner that protrudes from a central part of top surface 126. A cap member 160 is attached to an upper end of central protrusion 128.

With rotor 120 being mounted to drive shaft 150 and drug container 110 being kept closed, cap member 160 and cover 130 are facing each other with an interval therebetween. This interval may be less than or equal to 2 mm, preferably, less than or equal to 1 mm.

A plurality of first protrusions 122 and a plurality of second protrusions 123 are formed in a lower part of circumferential surface 121. These first and second protrusions are spaced apart at intervals 125 in the circumferential direction of rotor 120, as illustrated in FIGS. 5 and 7. First protrusions 122 and second protrusions 123 are each formed in a substantially rectangular shape when viewed in the radial direction of rotor 120. Upper surfaces of first protrusions 122 protrude in part toward higher positions than the lower surface of partitioning portion 140. Upper surfaces of second protrusions 123 are, on the whole, flat surfaces. Ends of first protrusions 122 and of second protrusions 123 in the radial direction of rotor 120 are slightly away from and facing the inner surface of circumferential wall 111.

First protrusions 122 and second protrusions 123 are formed in a manner that can push pieces of the drug housed in intervals 125 out of these intervals toward outlet 112 during the rotation of rotor 120. Specifically, pieces of the drug housed in intervals 125 are pushed by first protrusions 122 or second protrusions 123 along with the rotation of rotor 120 and are, while being pushed, transported in the circumferential direction of rotor 120 and dropped into outlet 112.

At least two third protrusions 124 are formed in circumferential surface 121. In this embodiment, one third protrusion 124 is disposed above a respective one of second protrusions 123, as illustrated in FIGS. 5 and 7. Ends of at least two third protrusions 124 in the radial direction of rotor 120 are slightly away from and facing the inner surface of circumferential wall 111.

As illustrated in FIG. 7, a passage G is provided between second protrusions 123 and third protrusions 124 that are vertically arranged. Partitioning portion 140 is permitted to travel through this passage G during the rotation of rotor 120. Passage G has a vertical width slightly greater than the thickness of partitioning portion 140. During the rotation of rotor 120, third protrusions 124 serve to push the drug housed in partitioning portion 140 away from this partitioning portion 140. During the rotation of rotor 120, part of upper surfaces of first protrusions 122 pushes partitioning portion 140 upward, so that the drug on partitioning portion 140 is moved away from this partitioning portion 140, as illustrated in FIG. 7.

Partitioning portion 140 is removably attached to circumferential wall 111 in the upper direction of outlet 112, as illustrated in FIGS. 3 and 6 to 8. Partitioning portion 140 extends from the inner surface of circumferential wall 111 toward a position above first protrusions 122 and second protrusions 123 formed on circumferential surface 121. Intervals 125 continuous to outlet 112 are covered with partitioning portion 140 to prevent accidental drop or entry of drug from the upper direction.

In this embodiment, partitioning portion 140 may be or may include a plastic member. To be specific, partitioning portion 140 has a plurality of plastic members formed on a substrate 141 having an arc-like shape, as illustrated in FIGS. 6 to 8. The plastic members are spaced apart at intervals along the arc-like shape of substrate 141. The plastic members are made from, for example, a soft synthetic resin material in this embodiment, partitioning portion 140 has a brush-like shape. Instead of this exemplified shape, partitioning portion 140 may have a plate-like shape.

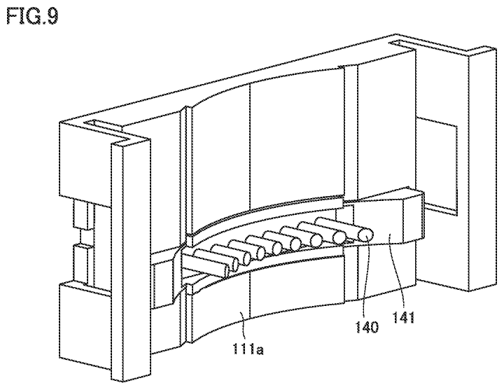

FIG. 9 is a perspective view of the partitioning portion that has been removed, as well as a partial circumferential wall, from the drug container in the cassette of the drug supply device according to an embodiment of this invention. As illustrated in FIG. 9, substrate 141 is attached to a cavity formed in a partial circumferential wall 111a which is a part of circumferential wall 111. Partial circumferential wall 111a is removably joined to the other portion of circumferential wall 111. To be specific, partial circumferential wall 111a is removably attached to drug container 110 by leveraging the snap-fitting structure.

Cassette 100 of the drug supply device according to an embodiment of this invention is further equipped with an attach-detach mechanism adapted to removably engage drive shaft 150 and rotor 120 with each other. The attach-detach mechanism of cassette 100 in the drug supply device according to an embodiment of this invention is hereinafter described.

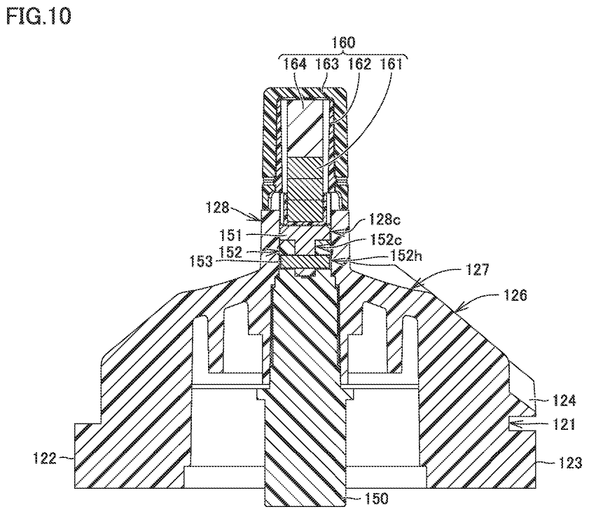

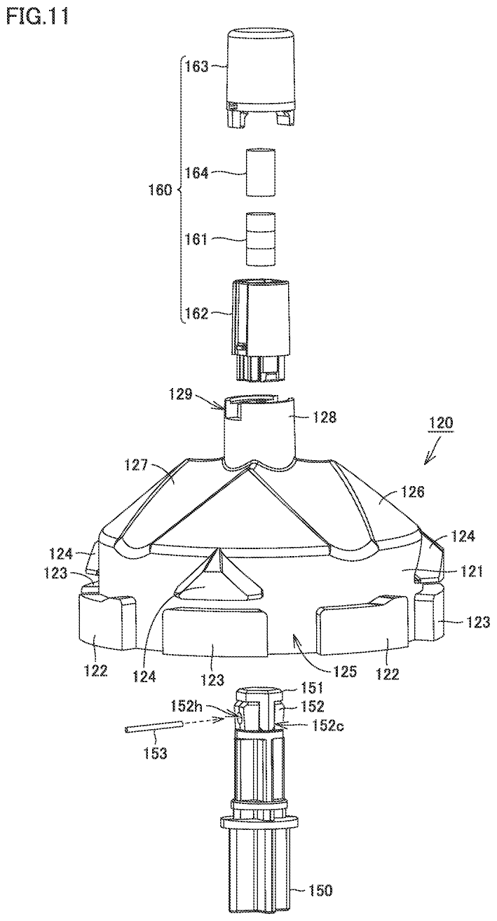

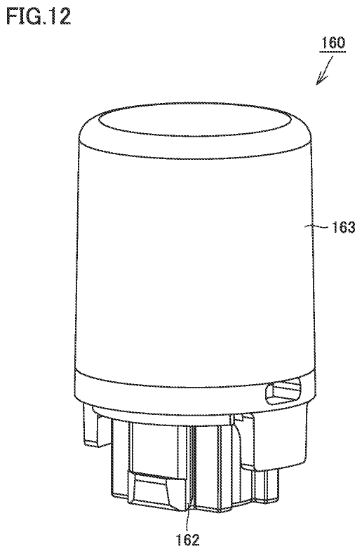

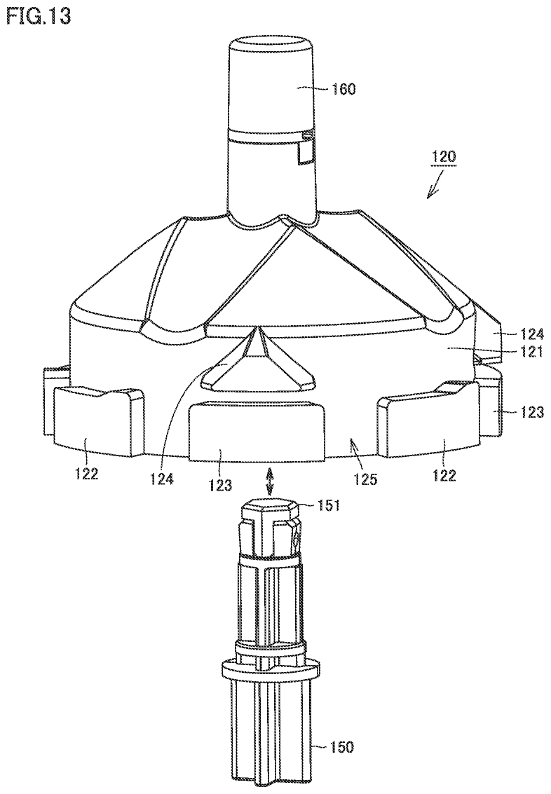

FIG. 10 is a cross-sectional view in a direction along an X-X line of the rotor and the drive shaft illustrated in FIG. 7. FIG. 11 is an exploded perspective view of the rotor, cap member and drive shaft in the cassette of the drug supply device according to an embodiment of this invention. FIG. 12 is perspective view that illustrates an external appearance of the cap member in the cassette of the drug supply device according to an embodiment of this invention. FIG. 13 is a perspective view that illustrates how the rotor is attachable and detachable to and from the drive shaft in the cassette of the drug supply device according to an embodiment of this invention. The partitioning portion is not illustrated in FIG. 10.

In this embodiment, the attach-detach mechanism includes a magnet 161 and a magnetic body 151, as illustrated in FIGS. 10 and 11. Magnetic body 151 is attached to an edge 152 of drive shaft 150. Specifically, drive shaft 150 has a cutout 152c and a through hole 152h, as illustrated in FIG. 11. Cutout 152c is formed at an edge 152 of drive shaft 150 in a manner that extends from the edge along the axial direction of drive shaft 150. Through hole 152h is formed in a direction orthogonal to the axial direction of drive shaft ISO.

As illustrated in FIG. 10, magnetic body 151, including its portions larger in width and smaller in width, has a substantially T-like shape in longitudinal cross section. This magnetic body has a through hole in the smaller-in-width portion. First, the smaller-in-width portion of magnetic body 151 is inserted in cutout 152c at edge 152 of drive shaft 150, while edge 152 of drive shaft 150 and the larger-in-width portion of magnetic body 151 are axially brought into contact with each other. Then, a spring pin 153 illustrated in FIG. 11 is inserted in through hole 152h at edge 152 of drive shaft ISO and also in the through hole in the smaller-in-width portion of magnetic body 151. As a result, magnetic body 151 is attached to edge 152 of drive shaft 150, as illustrated in FIG. 10.

Edge 152 of drive shaft 150 and magnetic body 151, when they are coupled to each other, form a hexagonal shape when viewed in the axial direction of drive shaft 150, as illustrated in FIG. 11. Magnetic body 151 includes a magnetic material, for example, SUS430.

Magnet 161 is embedded in cap member 160. To be specific, cap member 160 includes a magnet 161, a supporter 162, a cap 163, and a spacer 164. Supporter 162 has a cylindrical shape with a closed bottom. Magnet 161 is housed in and supported by this supporter. Cap 163 is removably engaged with supporter 162. In this embodiment, cap 163 and supporter 162, which are snap-fitted with each other in this description, may be otherwise engaged with each other, for example, with screws. Supporter 162 and cap 163 are formed using a resin material. Spacer 164 is interposed between magnet 161 and cap 163. Spacer 164 has a columnar shape and is formed using a resin material.

With cap 163 being engaged with supporter 162, magnet 161, as well as spacer 164, is securely fitted in a space surrounded by cap 163 and supporter 162, as illustrated in FIGS. 10 and 12. Magnet 161 may be or may include a neodymium magnet. As illustrated in FIG. 11, cap member 160 is engaged with cutout 129 formed at an edge of central protrusion 128 of rotor 120 and is thus attached to the edge of central protrusion 128.

After cap member 160 is attached to the edge of central protrusion 128, rotor 120 is removably mounted to drive shaft 150 in its axial direction, as illustrated in FIG. 13. With rotor 120 being mounted to drive shaft 150 in its axial direction, magnet 161 and magnetic body 151 are adjacent to each other in the axial direction of drive shaft 150, as illustrated in FIG. 10. In this embodiment, the bottom part of supporter 162 is located between magnet 161 and magnetic body 151.

In the structure described above, the magnetic force acting between magnet 161 and magnetic body 151 biases drive shaft 150 and rotor 120 toward each other in the axial direction of drive shaft 150. The attach-detach mechanism including magnet 161 and magnetic body 151 thus serves to bias drive shaft 150 and rotor 120 toward each other along the axial direction of drive shaft 150. This biasing action invites these shaft and rotor to removably engage with each other.

As illustrated in FIG. 10, a recess 128c is formed in the surface a shaft hole of rotor 120 for insertion of drive shaft 150. Recess 128c is engageable with the hexagonal shape of magnetic body 151. Edge 152 of drive shaft 150 and recess 128c of rotor 120 are engaged with each other, with magnetic body 151 being interposed therebetween, in the circumferential direction of drive shaft 150. This engagement may immovably stabilize relative positions of rotor 120 and drive shaft 150 in the circumferential direction of drive shaft 150.

The operation of cassette 100 in the drug supply device according to an embodiment of this invention is hereinafter described.

When rotor 120 rotates after drug container 110 is supplied with drug the drug on top surface 126 moves toward a space between the inner surface of circumferential wall 111 and circumferential surface 121 of rotor 120. While rotor 120 is rotating, grooves 127 agitate the drug on top surface 126, helping the drug move into the space.

The drug that moved into the space is partly housed in intervals 125; one tablet in each interval 125. Specifically, the drug tablets housed in intervals 125 are pushed by first protrusions 122 or second protrusions 123 along with the rotation of rotor 120 and are thereby transported in the circumferential direction of rotor 120. The drug tablets in interval 125 above and continuous to outlet 112, on the other hand, drop downward out of interval 125 into outlet 112 and then discharged out.

Interval 125 continuous to outlet 112 is covered with partitioning portion 140 to prevent accidental drop or entry of any drug from the upper direction. Thus, the drug, one piece or tablet at a time, may be successfully discharged through outlet 112. Cassettes 100 are each allowed to supply drug within a range of dimensions among all of target drugs to be supplied.

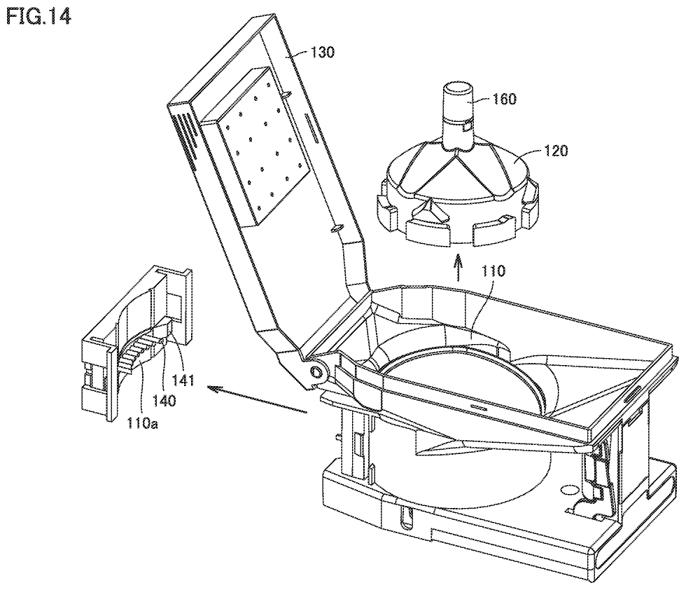

FIG. 14 is a perspective view that illustrates the cassette, before cleaning starts, of the drug supply device according to an embodiment of this invention after the partitioning portion, as well as the partial circumferential wall, is removed from the drug container and the rotor is then removed from the drive shaft. For cleaning of the interior of drug container 110, first, partitioning portion 140, as well as partial circumferential wall 111a, is removed from drug container 110. Then, rotor 120 is moved to slide along drive shaft 150 against the biasing force of the attach-detach mechanism to remove rotor 120, as illustrated in FIGS. 13 and 14.

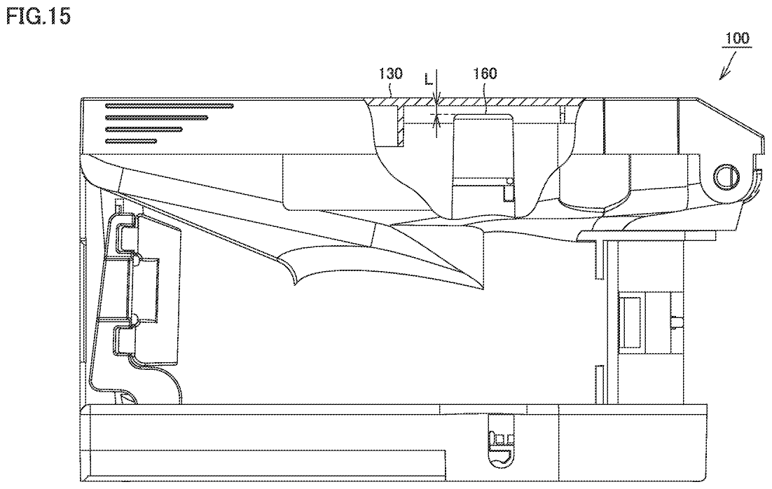

FIG. 15 is a lateral view that illustrates the cassette closed with a cover, after the cleaning ends, of the drug supply device according to an embodiment of this invention after the rotor is attached to the drive shaft and the partitioning portion, as well as the partial circumferential wall, is then put back into the drug container. When cleaning is over, drive shaft 150 is inserted into the shaft hole of rotor 120, and rotor 120 is then mounted to drive shaft 150 under the biasing force of the attach-detach mechanism, as illustrated in FIG. 15.

With rotor 120 being mounted to drive shaft 150 and drug container 110 being kept closed, cap member 160 and cover 130 are facing each other with an interval L therebetween. Interval L may be less than or equal to 2 mm. Preferably, interval L may be greater than or equal to 0.5 mm and less than or equal to 1 mm.

In this embodiment, magnetic body 151 is attached to edge 152 of drive shaft 150, and magnet 161 is attached to cap member 160. Instead, magnet 161 may be attached to edge 152 of drive shaft 150, and magnetic body 151 may be attached to cap member 160.

The attach-detach mechanism described herein magnetically biases drive shaft 150 and rotor 120 toward each other. Instead, springs may be used to bias drive shaft 150 and rotor 120 toward each other, like a ball-catch mechanism.

In cassette 100 of the drug supply device according to an embodiment of this invention, drug container 110 serves to contain drug and has outlet 112 to discharge the drug through this outlet 112. Rotor 120 is installed in the interior of drug container 110 and is rotated to transport the drug out of drug container 110 toward outlet 112. Drive shaft 150 is coaxial with rotor 120 and is rotatably secured to drug container 110. Rotor 120 is removably axially mounted to and rotated by drive shaft 150. The attach-detach mechanism serves to bias drive shaft 150 and rotor 120 toward each other along the axial direction of drive shaft 150. This biasing action invites these shaft and rotor to removably engage with each other.

Thus, rotor 120, by being simply moved in the axial direction of drive shaft 150, may be removably mounted to drive shaft 150. This may facilitate cleaning of the interior of cassette 100.

The biasing action using the attach-detach mechanism may prevent loose or insecure engagement between rotor 120 and drive shaft 150. The biasing action may also prevent rotor 120 from lifting up in case the drug is accidentally stuck between circumferential wall 111 and circumferential surface 121 of rotor 120. Further advantageously, rotor 120 may be prevented from falling off when, for example, drug container 110 is turned upside down.

In this embodiment, the attach-detach mechanism includes magnet 161 and magnetic body 151. The magnetic force acting between magnet 161 and magnetic body 151 biases drive shaft 150 and rotor 120 toward each other in the axial direction of drive shaft 150. The attach-detach mechanism may be thus simply structured.

In this embodiment, drive shaft 150 and rotor 120 are engaged with each other in the circumferential direction of drive shaft 150. This engagement may immovably stabilize relative positions of rotor 120 and drive shaft 150 in the circumferential direction of drive shaft 150. Rotor 120 may be thus accurately rotatable in response to the rotation of drive shaft 150.

In this embodiment, rotor 120 has inclined top surface 126 bulging upward and central protrusion 128 protruding from a central part of top surface 126. Rotor 120 thus structured may be mounted to and dismounted from the drive shaft by holding central protrusion 128.

In this embodiment, partitioning portion 140 is disposed in a manner that extends from the inner surface of circumferential wall 111 toward a position above first protrusions 122 and second protrusions 123 formed on circumferential surface 121 of rotor 120. This partitioning portion 140 is then removably attached to drug container 110. Thus, partitioning portion 140 may be removable from drug container 110 before rotor 120 is mounted to or removed from the drive shaft. This may prevent any interference of partitioning portion 140 with first protrusions 122 or second protrusions 123. In this manner, rotor 120 may be easily mounted to and removed from the drive shaft, as a result of which cleaning of the interior of cassette 100 may be facilitated.

In this embodiment, cover 130 is rotatably attached to drug container 110 to allow this drug container to open and close. Cap member 160 is attached to the upper end of central protrusion 128. With rotor 120 being mounted to drive shaft 150 and drug container 110 being kept closed, cap member 160 and cover 130 are facing each other with an interval L therebetween interval L may be less than or equal to 2 mm. In an event that rotor 120 is improperly mounted to drive shaft 150, cover 130 and cap member 160 may interfere with each other, leaving cover 130 unclosed. Hence, whether cover 130 is closed may be a useful criterion in determining whether rotor 120 is properly mounted to drive shaft 150.

A RFID tag is appended to each of cassettes 100. In the RFID tag is storable the identification information of each cassette including its cassette number.

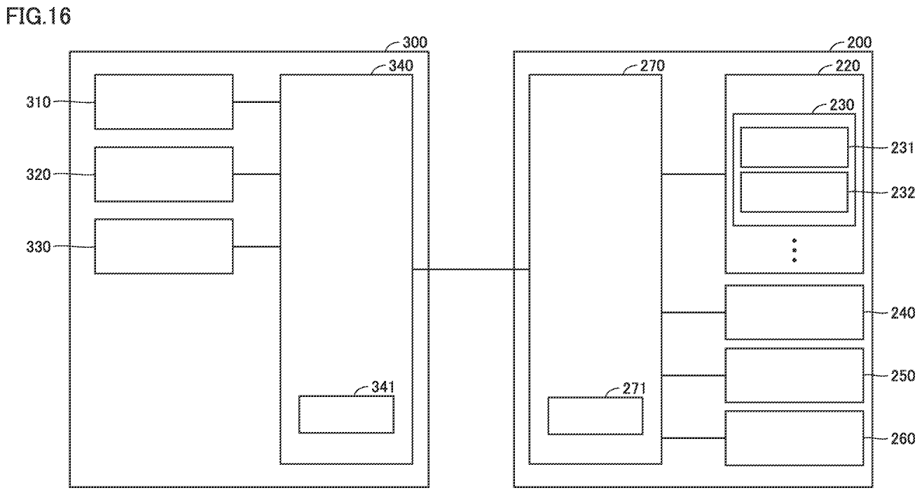

FIG. 16 is a block diagram that illustrates connections in the drug split-packaging apparatus including the drug supply device according to an embodiment of this invention. As illustrated in FIG. 16, drug split-packaging apparatus 200 including the drug supply device according to an embodiment of this invention has a controller 270. Controller 270 is electrically connected to tablet supplier 220, manual drug supply cassette 240, powdered drug supplier 250, and packaging device 260. Controller 270 is also electrically connected to a controller 340 of control device 300 described later. Controller 270 has a storage 271.

Controller 270 further includes a CPU (Central Processing Unit), RAM (Random access memory), ROM (Read Only Memory), and EEPROM (Electrically Erasable Programmable Read-Only Memory). Controller 270 may be an integrated circuit, examples of which include ASIC (application specific integrated circuit) and DSP (digital signal processor). Storage 271 may be a hard disc or SSD (Solid State Drive) in which various pieces of data are storable.

At each of cassette positions 230 are disposed a driver 231 that drives cassettes 100 and a RFID reader/writer 232. Driver 231 includes a drive motor that drives drive shaft 150 of cassette 100. The drive motor is driven to operate by controller 270. Driven 231 are each mountable with each of cassettes 100 and drive cassettes 100 mounted thereto. RFID reader/writer 232 reads information from the RFID tag on each cassette 100 mounted to driver 231. The information read by RFID) reader/writer 232 is inputted to controller 270.

Controller 270 allocates drug information of a target drug to driver 231 selected from drivers 231 mounted with cassettes 100. When one of cassettes 100 is mounted to one of drivers 231, controller 270 allocates the target drug information to cassette-mounted driver 231. To be specific, controller 270 allocates the target drug information to driver 231 detected by RFID reader/writer 232 as being mounted with cassette 100.

Controller 270 controls drivers 231 so that the target drug is supplied from cassette 100 mounted to driver 231 to which the drug information has been allocated under a drive condition pursuant to the allocated drug information. Controller 270 controls drivers 231 individually.

The operation of manual drug supply cassette 240 is controlled by controller 270. The operation of powdered drug supplier 250 is controlled by controller 270. The operation of packaging device 260 is controlled by controller 270.

Control device 300 includes an operating portion 310, a displayer 320, a reader 330 and a controller 340. Controller 340 is electrically connected to operating portion 310, displayer 320 and reader 330. Controller 340 has a storage 341.

Controller 340 includes, for example, CPU, RAM, ROM and EEPROM. Controller 340 may be an integrated circuit, examples of which include ASIC and DSP. Storage 341 may be a hard disc or SSD in which various pieces of data are storable.

Operating portion 310 may include a keyboard, mouse and touch panel, through which a user's operation inputs are received. The operation inputs received through operating portion 310 are then inputted to controller 340.

Displayer 320 may include a liquid crystal monitor. Displayer 320 displays a screen based on signal outputs from controller 340. Displayer 320 is capable of displaying information relevant to allocation of the drug information. In this embodiment, displayer 320 is an operation panel integral with operating portion 310.

Reader 330 reads an identification code appended to a drug holder. The drug holder may be, for example, a bottle or a box. The identification code may be a barcode or QR (Quick Response) code. The information read by reader 330 is inputted to controller 340.

The display of items and operational steps of displayer 320 in the drug supply device according to an embodiment of this invention are hereinafter described.

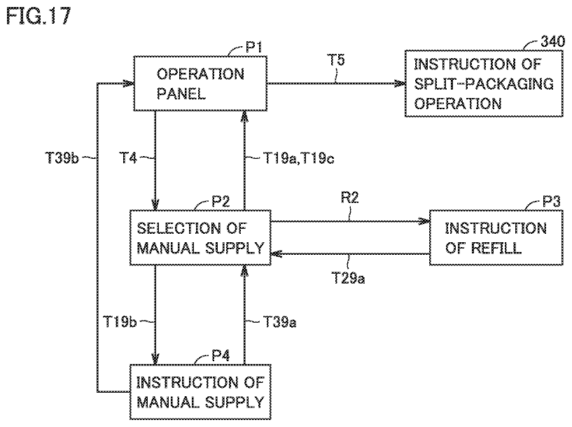

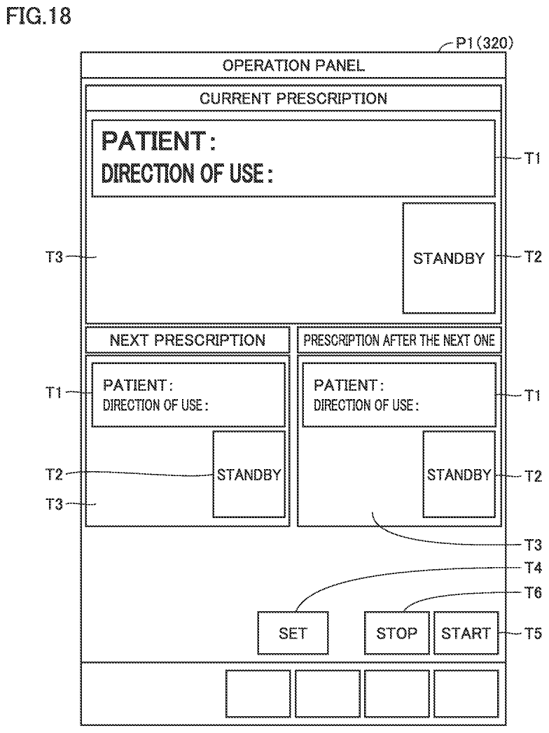

FIG. 17 is a block diagram that illustrates operational steps in the drug split-packaging apparatus including the drug supply device according to an embodiment of this invention. FIG. 18 is a drawing that illustrates an initial display of a prescription screen displayed on the operation panel of the drug supply device according to an embodiment of this invention. As illustrated in FIGS. 17 and 18, a prescription screen P1 displayed by displayer 320 of the drug supply device according to an embodiment of this invention provides indications of the following fields; prescription information field T1, operation status field T2, packaged pouch number field T3, display-start input field T4, packaging-start input field T5, and operation-stop input field T6.

Prescription information field T1 displays prescription-related information in one prescription. Operation status field T2 displays the current operation status of drug split-packaging apparatus 200. Packaged pouch number field T3 displays the number of packaged drug-containing pouches. Display-start input field T4 is an operation input field for display of a list of manually packaged drugs. The manually packaged drugs displayed on the screen of displayer 320 includes drugs supplied from cassettes 100, as well as drugs supplied from manual drug supply cassette 240.

Packaging-start input field T5 is an operation input field for prompting drug split-packaging apparatus 200 to start its packaging operation. Operation-stop input field T6 is an operation input field for prompting drug split-packaging apparatus 200 to stop its packaging operation.

In displayer 320 of the drug supply device according to this embodiment, prescription screen P1 may display pieces of information associated with three prescriptions; currently issued prescription, next prescription and prescription after the next one, as illustrated in FIG. 18. These pieces of prescription-related information are stored in storage 341 illustrated in FIG. 16 when each of them is inputted through operating portion 310. Then, the pieces of information are read out whenever necessary from storage 341 and displayed on prescription screen P1 of displayer 320.

Pieces of prescription-related and packaging-related information are inputted to displayer 320, in response to which prescription information including the patient name and direction of use is displayed in prescription information field T1 on prescription screen P1 of displayer 320. Then, the current indication on operation status field T2, “standby”, is changed “currently packaging”, and the number of packaged pouches is displayed in packaged pouch number field T3.

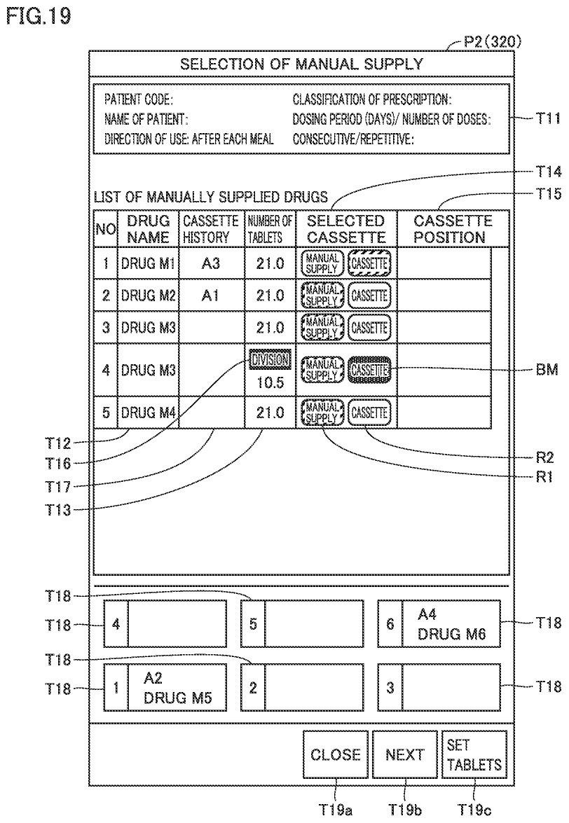

FIG. 19 is a drawing that illustrates a selection screen displayed on the operation panel of the drug supply device according to an embodiment of this invention. In response to an operation input to display-start input field T4 on prescription screen P1 of FIG. 18, as illustrated in FIG. 17, controller 340 illustrated in FIG. 16 causes displayer 320 to display a selection screen P2, as illustrated in FIG. 19. Selection screen P2 is a screen for choosing cassette 100 or manual drug supply cassette 240 for the target drug supply.

As illustrated in FIG. 19, selection screen P2 displayed by displayer 320 of the drug supply device according to the embodiment of this invention provides indications of the following fields; prescription information field T11, manual supply list field T12, tablet number field T13, region selection field T14, cassette position field T15, specified drug field T16, cassette record field T17, allocated drug information field T18, first switchover input field T19a, second switchover input field T19b, and third switchover input field T19c.

Prescription information field T11 displays prescription-related information in one prescription. Manual supply list field T12 displays a list of pieces of target drug information.

Tablet number field T13 displays a required number of drug tablets in one prescription. As illustrated in FIG. 19, selection screen P2 displays a required number of drug tablets in one prescription for each piece of target drug information. The list of target drug information in manual supply list field T12 on selection screen P2 may be rearranged in the order of greater or smaller numbers displayed as the required number of drug tablets in one prescription in tablet number field T13.

Region selection field T14 displays two selected regions; one is manual drug supply cassette 240, and the other is cassette 100. Controller 340 is capable of accepting an operation input for selecting which of cassette 100 and manual drug supply cassette 240 supplies the target drug.

Cassette position field T15 displays the number representing cassette position 230 at which cassette 100 is disposed.

Specified drug field T16 displays identification information to identify whether the target drug is a specified drug that can only be supplied from manual drug supply cassette 240. Cassette 100 is unusable to supply such a specified drug Examples of the specified drug may include drugs divided in half and drugs having particular shapes. The drugs divided in half, mentioned above, may instead be divided in three or more portions. The particular shapes may include spherical shapes that are easy to roll over.

In an event that a drug M3; No. 4 in the manual supply list field, is a drug divided in two or more portions, specified drug field T16 displays a mark signifying division as the specified-drug identification information, as illustrated in FIG. 19. In region selection field T14 for the drug M13; No. 4 in the manual supply list field, a selected region R1 for manual drug supply cassette 240 is changed to a specified selected region, and a selected region R2 for any region but the specified selected region is displayed in an identification color BM signifying “not selectable”. Further, controller 340 no longer accepts any operation input for selection.

Supposing that drug M3; No. 4 in the manual supply list field, has a particular shape, specified drug field T16 displays a mark of disapproval. In region selection field T14 for the drug M3; No. 4 in manual supply list field, selected region R1 for manual drug supply cassette 240 is changed to a specified selected region, and selected region R2 for any region but the specified selected region is displayed in identification color KM signifying “not selectable”. Further, controller 340 no longer accepts any operation input for selection.

Controller 340 causes displayer 320 to display drugs that can be supplied from and that cannot be supplied from cassette 100 in a distinguishable manner. For any drug that cannot be supplied from cassette 100, controller 340 does not accept an operation input for drug supply from cassette 100.

Further, controller 340 does not accept any operation input for drug supply from cassette 100 on selection screen P2 in an event that none of drivers 231 is mountable with cassette 100.

In this embodiment, specified drug field T16 is displayed on the inside of tablet number field T13 The position of specified drug field T16 to be displayed, however, is not necessarily limited to tablet number field T13.

On selection screen P2, whether the target drug is a specified drug that can only be supplied from manual drug supply cassette 240 alone is displayed in a distinguishable manner for each piece of target drug information. Controller 340 causes displayer 320 to display drugs that can be supplied from and that cannot be supplied from cassettes 100.

Cassette record field T17 displays identification information of cassette 100 that most recently supplied the drug on the list of target drugs. Controller 340 causes displayer 320 to display the history of use of cassettes 100. The history of use of cassettes 100 is stored in storage 271 or storage 341. In regard to any one in the list of target drugs recorded as being used by cassette 100, identification information of cassette 100 that most recently supplied the drug is displayed in cassette record field T17. Thus, controller 340 causes displayer 320 to display the identification information of cassette 100 that most recently supplied the target drug.

Allocated drug information fields T18 are displayed correspondingly to cassette positions 230 of drivers 231 illustrated in FIG. 1. Allocated drug information fields T18 are displayed with the target drug information allocated by controller 270 to each of drivers 231.

First switchover input field T19a receives an operation input for closing selection screen P2. Second switchover input field T19b receives an operation input for causing displayer 320 to display manual supply instructing screen P4. Third switchover input field T19c receives an operation input for checking whether all of the target drugs to be supplied have been divided and packaged.

In response to an operation input to first switchover input field T19a or third switchover input field T19c on selection screen P2 of FIG. 19, as illustrated in FIG. 17, controller 340 illustrated in FIG. 16 causes displayer 320 to display prescription screen P1. In response to an operation input to second switchover input field T19b on selection screen P2 illustrated in FIG. 19, controller 340 illustrated in FIG. 16 causes displayer 320 to display manual supply instructing screen P4.

When an operation input for selected region R2 is received on selection screen P2, for example, one drug in the list of target drugs is chosen to be supplied from cassette 100, as illustrated in FIG. 17. Then, displayer 320 displays refill instructing screen P3 for refill of the one drug in cassette 100 mounted to any one of drivers 231.

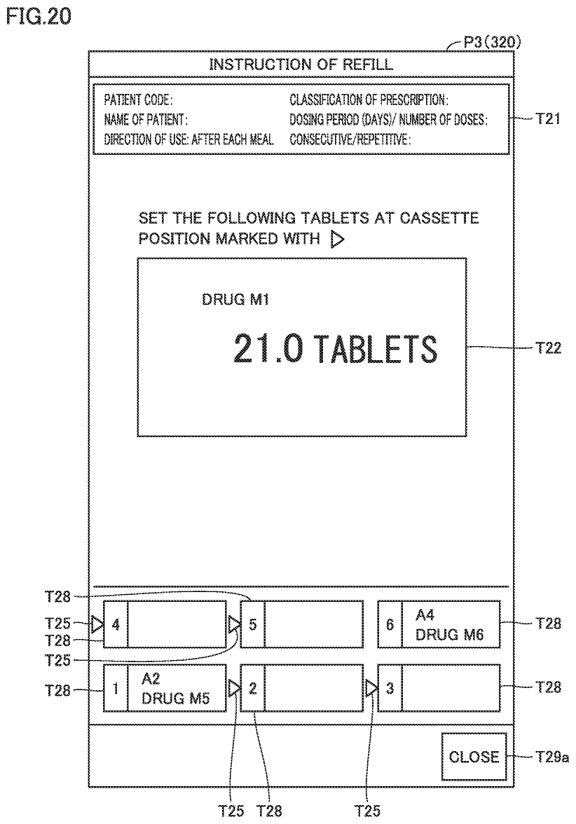

FIG. 20 is a drawing that illustrates the refill instructing screen displayed on the operation panel of the drug supply device according to an embodiment of this invention. Refill instructing screen P3 is for instructing which drug and how many tablets of the drug need to be supplied for refill into cassette 100 mounted to one of drivers 231 at six cassette position 230.

As illustrated in FIG. 20, refill instructing screen P3 displayed by displayer 320 of the drug supply device according to an embodiment of this invention provides indications of the following field; prescription information field T21, refill drug information field T22, a plurality of selected regions T28, and a first switchover input field T29a.

Prescription information field T21 displays prescription-related information in one prescription. Refill drug information field T22 displays the target drug information and a required number of tablets of the drug for refill. Thus, controller 340 causes displayer 320 to display a required number of tablets of the target drug for refill.

The plurality of selected regions T28 are indicated correspondingly to cassette positions 230. Specifically, six selected regions T28 are indicated correspondingly to cassette positions 230 illustrated in FIG. 1. Among a plurality of selected regions T28, the allocated drug information is displayed in selected region T28 for cassette position 230 of driver 231 to which the drug information has been allocated. Among a plurality of selected regions T28, an identification nark T25 is displayed in selected region T28 for cassette position 230 of driver 231 to which the drug information is yet to be allocated. Controller 340 causes displayer 320 to display a plurality of selected regions T28 so that driver 231 mountable with cassette 100 and driver 231 not mountable with cassette 100 are distinguishable from each other.

First switchover input field T29a receives an operation input for closing refill instructing screen P3. In response to an operation input to first switchover input field T29a on refill instructing screen P3 illustrated in FIG. 20, controller 340 illustrated in FIG. 16 causes displayer 320 to display selection screen P2, as illustrated in FIG. 17.

When cassette 100 is mounted to driver 231 at cassette position 230 corresponding to any one of selected region T28 with identification mark T25, as indicated by refill instructing screen P3, controller 270 allocates the target drug information to driver 231 detected by RFID reader/writer 232 as being mounted with cassette 100. Upon receipt of information of driver 231 to which the target drug information has been allocated by controller 270, controller 340 causes displayer 320 to display the drug information corresponding to the relevant cassette position 230 in allocated drug information field T18 on selection screen P2.

Manual supply instructing screen P4 is for instructing which one of compartments of manual drug supply cassette 240 should be manually supplied with how many drug tablets. Controller 340, in accordance with the prescription information and split-packaging information, causes displayer 320 to display manual supply instructing screen P4 that provides indications of compartment regions RD that respectively correspond to the compartments.

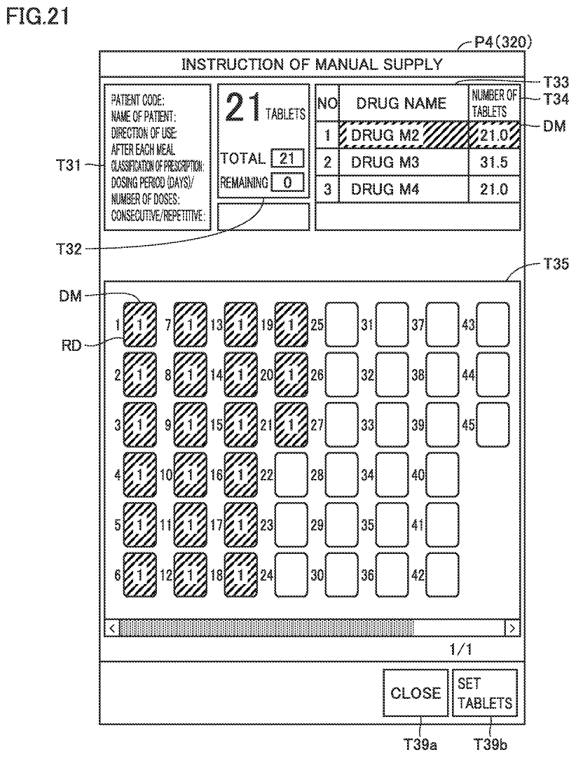

FIG. 21 is a drawing that illustrates the manual supply instructing screen displayed on the operation panel of the drug supply device according to an embodiment of this invention. As illustrated in FIG. 21, manual supply instructing screen P4 displayed by displayer 320 of the drug supply device according to an embodiment of this invention provides indications of the following fields, prescription information field T31, packaged pouch number field T32, manual supply list field T33, tablet number field T34, compartment region field T35, first switchover input field T39a, and third switchover input field T39b.

Prescription information field T31 displays prescription-related information in one prescription. Packaged pouch number field T32 displays the number of packaged pouches in one prescription. Manual supply list field T33 displays a list of drugs manually supplied from manual drug supply cassette 240. In manual supply list field T33, an operator is allowed to select a drug(s) from the list of manually supplied drugs. In manual supply list field T33, a drug currently selected is displayed in an identification color DM.

Tablet number field T34 displays a required number of manually supplied drug tablets in one prescription. In tablet number field T34, the number of tablets of the currently selected drug is displayed in identification color DM.

Compartment region field T35 displays a plurality of compartment regions RD that respectively correspond to the compartments. Compartment regions RD are displayed in the same layout as the compartments. For direction of use of drug M2 after each meal, for example, compartment region field T35 displays the following based on the prescription information and split-packaging information. No. 1 to No. 21 compartment regions RD, among all of the compartment regions RD, are displayed in identification color DM, indication of drug to be manually supplied, and “l” is also displayed in these compartment regions as the required number of drug M2 tablets for one dose, as illustrated in FIG. 21.

First switchover input field T30a receives an operation input for closing manual supply instructing screen P4. Third switchover input field T39b receives an operation input for checking whether all of the target drugs to be supplied have been divided and packaged.

In response to an operation input to first switchover input field T39a on manual supply instructing screen P4 illustrated in FIG. 21, controller 340 illustrated in FIG. 16 causes displayer 320 to display selection screen P2, as illustrated in FIG. 17. In response to an operation input to third switchover input field T39b on manual supply instructing screen P4 illustrated in FIG. 21, controller 340 illustrated in FIG. 16 causes displayer 320 to display prescription screen P1.

In response to an operation input to packaging-start input field T5 on prescription screen P1 illustrated in FIG. 18, controller 340 illustrated in FIG. 16 outputs a packaging instruction to controller 270 illustrated in FIG. 16, and the split-packaging operation of dug split-packaging apparatus 200 starts, as illustrated in FIG. 17.

In response to an operation input to operation-stop input field T6 on prescription screen P1 illustrated in FIG. 18, controller 340 illustrated in FIG. 16 outputs an operation-stop instruction to controller 270 illustrated in FIG. 16, and the split-packaging operation of drug split-packaging apparatus 200 is suspended.

Displayer 320 displays thereon the history of use of cassettes 100. Controller 340 causes displayer 320 to display the history of use of cassettes 100 based on the history of use of cassettes 100 stored in storage 271 or storage 341.

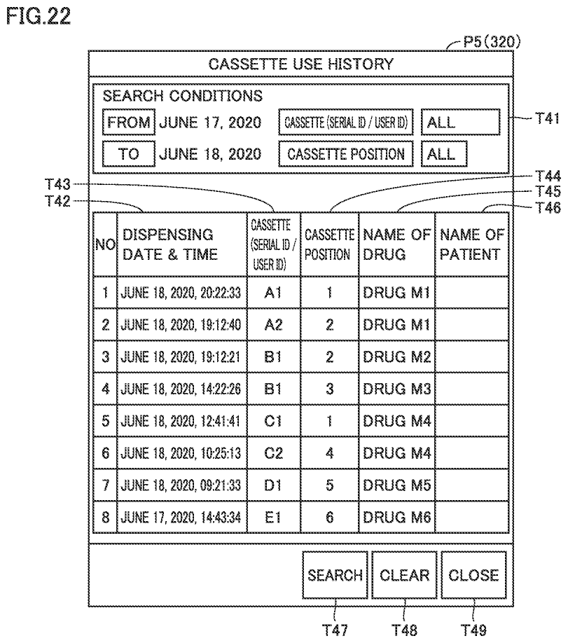

FIG. 22 is a drawing that illustrates a cassette use history screen displayed on the operation panel of the drug supply device according to an embodiment of this invention. As illustrated in FIG. 22, cassette use history screen P5 displayed by displayer 320 of the drug supply device according to an embodiment of this invention provides indications of the following fields; search condition field T41, dispensing date/time field T42, cassette identification information field T43, cassette position field T44, drug information field T45, patient field T46, first switchover input field 147, second switchover input field T48, and third switchover input field T49.

Search condition field T41 displays targets to be searched, a period set for dispensing date/time, cassette identification information, and numbers signifying cassette positions 230. Dispensing date/time field T42 displays dispensing dates and times when cassette 100 was used. Cassette identification information field T43 displays identification information of used cassettes 100. Cassette position field T44 displays the numbers signifying cassette positions 230 of the used cassettes 100. Drug information field T45 displays information of drugs supplied from the used cassettes 100. Patient field T46 displays the names of patients for whom the drugs supplied from the used cassettes 100 were prescribed.

First switchover input field T47 receives an operation input for starting searches. Second switchover input field T48 receives an input operation for returning to an initial display of cassette use history screen P5. Third switchover input field T49 receives an input operation for closing cassette use history screen P5.

For shortage of the drug supply, displayer 320 displays a shortfall of the drug on refill instructing screen P3.

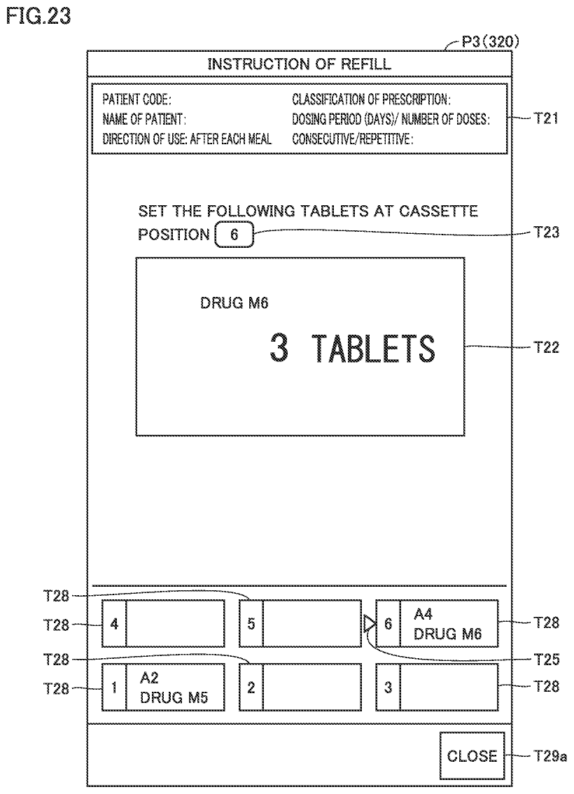

FIG. 23 is a drawing that illustrates the refill instructing screen displayed for drug shortage on the operation panel of the drug supply device according to an embodiment of this invention. As illustrated in FIG. 23, refill instructing screen P3 displayed by displayer 320 of the drug supply device according to the embodiment of this invention provides an indication of refill cassette position field T23 at the time of shortage of the drug supply, and identification mark 125 is displayed in selected region T28 corresponding to cassette position 230 targeted for refill. Further, a drug shortfall is displayed in refill drug information field T22 Controller 340 causes displayer 320 to display a shortfall of the target drug in an event of shortage of the target drug.

As an optional setting may be set prior checking to determine whether drug for refill of cassette 100 is the target drug before the refill is done. After the setting of prior checking is done, an identification code on the drug holder is read by reader 330 illustrated in FIG. 16. In storage 341 is stored master data in which identification codes and pieces of drug information are associated with each other. Controller 340 checks the target drug information against the drug information associated with the identification code red by reader 330.

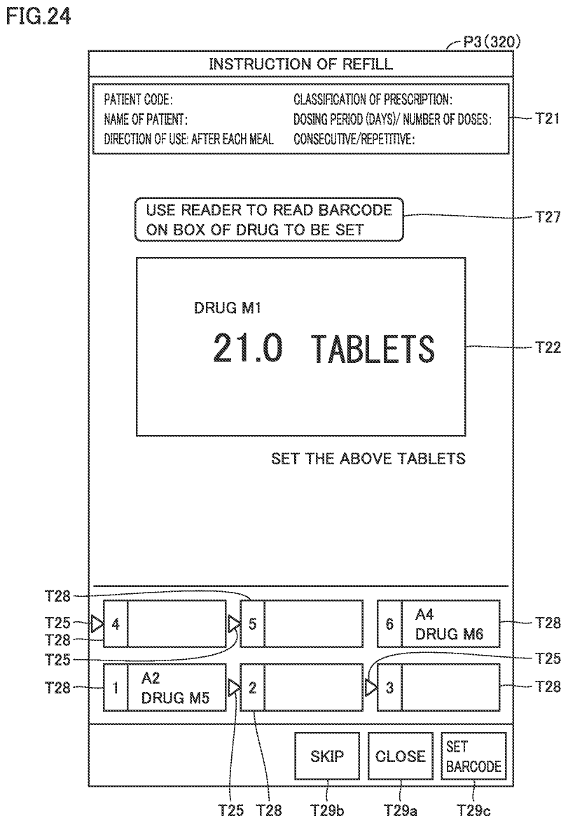

FIG. 24 is a drawing that illustrates the refill instructing screen displayed on the operation panel in which the prior checking has been set before the identification code is read by the reader. Before the identification code is read by reader 330, refill instructing screen P3 displayed by displayer 320 provides an indication of attention field T27 that invites a user to read the identification code using reader 330, as illustrated in FIG. 24. Refill instructing screen P3 provides indications of first switchover input field T29a, second switchover input field T29b, and third switchover input field T29c.

First switchover input field T29a receives an operation input for closing refill instructing screen P3 Second switchover input field T29b receives an operation input for skipping the prior check. Third switchover input field T29c receives an operation input for updating the master data stored in storage 341 in which pieces of drug information and identification codes are associated with each other.

In case the drug information associated with the identification code read by reader 330 is inconsistent with the target drug information on refill instructing screen P3 in which the prior checking has been set, third switchover input field T19c becomes inactive for any input operation on selection screen P2 if an operator manipulates first switchover input field T29a and returns to selection screen P2.

Thus, controller 340 causes displayer 320 to display, on refill instructing screen P3, an indication that calls for an operator's attention, inviting him/her to read the identification code using reader 330 and thereby check the target drug information against the drug information associated with the identification code.

When the drug packaging operation for one prescription by drug split-packaging apparatus 200 is over, cassettes 100 that completed the supply of a required number of drug tablets in one prescription is on standby for cleaning, and the target drug information remains allocated to drivers 231 mounted with these standby cassettes 100. Specifically, the target drug information allocated to drivers 231 continues to be stored in storage 341.

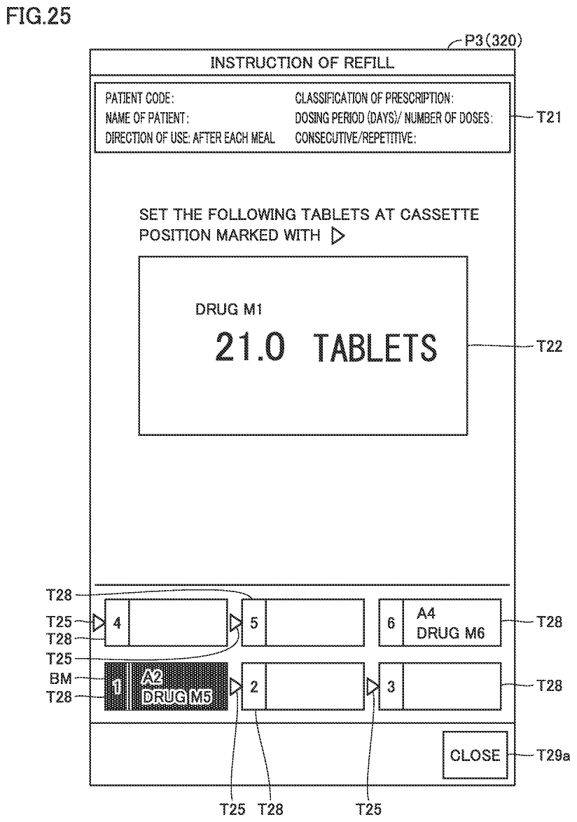

FIG. 25 is a drawing that illustrates the refill instructing screen displayed on the operation panel of the drug supply device according to an embodiment of this invention when any cassette is waiting to be cleaned. As illustrated in FIG. 25, refill instructing screen P3 of displayer 320 in the drug supply device according to the embodiment of this invention displays, in identification color BM, selected region T28 corresponding to cassette position 230 of cassette 100 waiting to be cleaned, when any cassette is waiting to be cleaned.

When drug information that differs from the drug information already allocated to driver 231 on standby for cleaning is allocated to a plurality of drivers 231, controller 340 does not display identification mark T25 in selected region T28 corresponding to cassette positions 230 of a standby cassette(s) on refill instructing screen P3.

In this embodiment, cassette 100 on standby for cleaning may be supplied with the same drug as in the previous drug supply while keeping the standby condition. In this instance, cassette 100 displayed in cassette record field T17 on selection screen P2 illustrated in FIG. 19, if waiting to be cleaned, is supplied with the same drug as in the previously drug supply.

For any trouble in RFID reader/writer 232 or driver 231 at cassette position 230, this cassette position 230 is stored in storage 341.

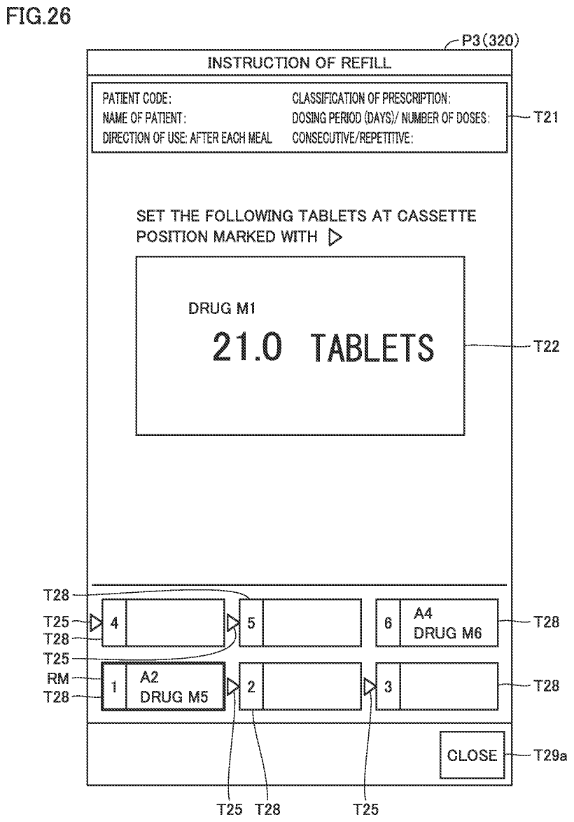

FIG. 26 is a drawing that illustrates the refill instructing screen displayed on the operation panel of the drug supply device according to an embodiment of this invention for trouble at any cassette position. As illustrated in FIG. 26, refill instructing screen P3 of displayer 3120 in the drug supply device according to the embodiment of this invention displays, in an identification color RM, selected region T28 corresponding to cassette position 230 of driver 231 or RFID reader/writer 232 undergoing any trouble.

Controller 340 does not allow identification mark T25 to be displayed in selected region T28 corresponding to such troubled cassette position 230 on refill instructing screen P3.

Controller 340 causes displayer 320 to display a plurality of selected regions T28 in a manner that driver 231 mountable with cassette 100 and driver 231 not mountable with cassette 100 are distinguishable front each other.

In the drug supply device according to the embodiment of this invention, cassettes 100 are each capable of supplying drug within a range of dimensions. A plurality of drivers 231 are each mountable with each of cassettes 100 and drive cassettes 100 mounted thereto. The controller controls drivers 231 individually. The controller allocates the drug information of the target drug to cassette 100 selected in accordance with dimensions of the target drug or to driver 231 mounted with cassette 100 thus selected. The controller controls drivers 231 so that the target drug is supplied from cassette 100 to which the drug information has been allocated or from cassette 100 mounted to driver 231 to which the drug information has been allocated.

This may allow a user who operates the drug supply device to easily configure and set the drug supply device so that drugs within a range of dimension can be divided and packaged as prescribed.

In the drug supply device according to an embodiment of this invention, the controller is capable of accepting an operation that is input for selecting which of cassette 100 and manual drug supply cassette 240 supplies the target drug. Thus, the drug supply device can readily decide which of the target drugs should be supplied from cassette 100.

In the drug supply device according to an embodiment of this invention, the controller does not accept an operation that is input for selecting the drug supply from cassette 100 in an event that none of drivers 231 is mountable with cassette 100. Any operation input for wrong selection may be thus avoidable.

In the drug supply device according to an embodiment of this invention, the controller does not accept an operation that is input for supply, from cassette 100, of the drug that can be supplied from none of cassettes 100. Any operation input for wrong selection may be thus avoidable.

The drug supply device according to an embodiment of this invention, further includes displayer 320 that is capable of displaying information concerning allocation of the drug information. This may allow an operator to readily decide which of driver 231 or cassette 100 can be targeted for allocation of the drug information.

In the drug supply device according to an embodiment of this invention, the controller causes displayer 320 to display the driver 231 to which cassette 100 is mountable and the driver 231 to which cassette 100 is not mountable in a distinguishable manner. This may avoid the risk of cassette 100 being accidentally mounted to any driver 231 not mountable with cassette 100.

In the drug supply device according to an embodiment of this invention, the controller causes displayer 320 to display the drug that can be supplied from cassette 100 and the drug that cannot be supplied from cassette 100 in a distinguishable manner. This may avoid the risk of cassette 100 being supplied with any unwanted drug.

In the drug supply device according to an embodiment of this invention, the controller causes displayer 320 to display the history of use of cassettes 100. Thus, whether cassettes 100 should be cleaned, for example, may be appropriately decided.

In the drug supply device according to an embodiment of this invention, the controller causes displayer 320 to display identification information of cassette 100 that most recently supplied the target drug. Thus, any driver 231 or cassette 100 to which the drug information can be allocated may be appropriately determined without cleaning of cassettes 100.

In the drug supply device according to an embodiment of this invention, the controller causes displayer 320 to display a required number of tablets of the target drug for refill. This may allow a user who operates the drug supply device to readily know how many tablets of the target drug are needed for refill.

In the drug supply device according to an embodiment of this invention, the controller causes displayer 320 to display a shortfall of the target drug in an event of shortage of the target drug. This may allow a user who operates the drug supply device to readily know a shortfall of the target drug.

In the drug supply device according to an embodiment of this invention, the controller checks the drug information against a result read and obtained by reader 330. This may avoid the risk of cassette 100 being supplied with any unwanted drug.

In the drug supply device according to an embodiment of this invention, the controller allocates the drug information to driver 231 when cassette 100 selected in accordance with dimensions of the target drug is mounted to this driver 231. Thus, a user who operates the drug supply device may no longer have to allocate the target drug information using operating portion 310.

This embodiment so far described an example in which the target drug information is allocated to driver 231 mounted with cassette 100. The target drug information may instead be allocated to cassette 100 mounted to driver 231. In this instance, the various structural and functional features of the drug supply device described earlier may likewise exert the operational effects.

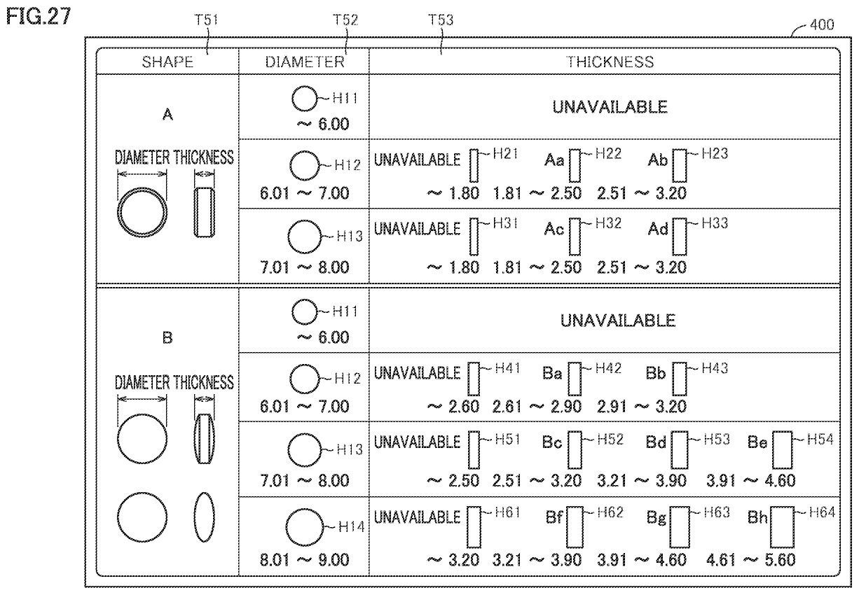

The cassette selecting tool of the drug supply device according to an embodiment of this invention is hereinafter described. FIG. 27 is a plan view that illustrates the cassette selecting tool in the drug supply device according to an embodiment of this invention. As illustrated in FIG. 27, a cassette selecting tool 400 of the drug supply device according to an embodiment of this invention has a plate-like shape. Cassette selecting tool 400 is capable of selecting, from a plurality of cassettes 100, cassette 100 that can supply drug in accordance with dimensions of the drug. An operator selects, from a plurality of cassettes 100, cassette 100 suitable for dimensions of the drug to be supplied using cassette selecting tool 400. Thus, cassette selecting tool 400 is used to select, from a plurality of cassettes 100, cassette 100 suitable for dimensions of the drug to be supplied.

Cassette selecting tool 400 provides indications of the following fields, drug shape field T51, drug diameter field T52, and drug thickness field T53 Drug shape field T51 is used to determine shapes of drug. Drug diameter field T52 is used to determine the range of diameters of drug. Drug thickness field T53 is used to determine the range of thicknesses of drug. An operator, who determines the shape, range of diameters, and range of thicknesses of drug while viewing drug shape field T51, drug diameter field T52 and drug thickness field T53 in the mentioned order, may be allowed to select cassette 100 that can supply the drug thus determined in shape and dimension.

In drug shape field T51 are indications of planar shapes and lateral shapes of a plurality of types of drugs that variously differ in shape, as illustrated in FIG. 27. This field may allow an operator to determine one of the indicated shape in which the target drug shape is included. In this embodiment, two different shapes are displayed; one is A type which is a disc-like shape (circular planar shape with flattened center), and the other is 1 type which is a convex lens-like shape (circular planar shape with swollen center). Drug shape field T5 may provide indications of three or more different shapes instead of these two shapes.

In drug diameter field T52 are formed a plurality of first through holes for different shape types. These first through holes have a circular shape and differ in diameter from one another. Three first through holes H11 to H13 are formed for the A-type drug shape. Four first through holes H11 to 1114 are formed for the B-type drug shape.

Different ranges of drug diameters are displayed correspondingly to the first through holes. In the vicinity of first through hole H11 is indicated that the range of drug diameters is less than or equal to the diameter of first through hole H11. In the vicinity of first through hole H12 is indicated that the range of drug diameters is greater than or equal to the diameter of first through hole H11 and less than or equal to the diameter of first through hole H12. In the vicinity of first through hole H13 is indicated that the range of drug diameters is greater than or equal to the diameter of first through hole H12 and less than or equal to the diameter of first through hole H13. In the vicinity of first through hole H14 is indicated that the range of drug diameters is greater than or equal to the diameter of first through hole H13 and less than or equal to the diameter of first through hole H14. The diameters of first through holes H11 to H14 are, respectively, 6 mm, 7 mm, 8 mm, and 9 mm.

When drug is fitted into one after another of first through holes H11 to H14 in the order of smaller to larger diameters, the drug is determinable as having a diameter within a certain range of dimensions based on the diameter of one of these through holes which the drug is first permitted to pass through. To be specific, the range of numeral values indicated in the vicinity of first through hole that the drug first passed through may be determined as the range of diameters of the drug.

In drug thickness field T53 are formed a plurality of second through holes for different drug shapes and drug diameters. These second through holes have a rectangular shape and differ in width from one another. Three second through holes H21 to H23 are formed for the A-type drug shape with diameters of 6.01 mm to 7.00 mm. Three second through holes H31 to H33 are formed for the A-type drug shape with diameters of 7.01 mm to 8.00 mm. Three second through holes H41 to H43 are formed for the B-type drug shape with diameters of 6.01 mm to 7.00 mm. Four second through holes H51 to H54 are formed for the B-type drug shape with diameters of 7.01 mm to 8.00 mm. Four second through holes H61 to H64 are formed for the B-type drug shape with diameters of 8.01 mm to 9.00 mm. There is no second through hole for drug shapes and diameters beyond the allowable ranges of cassettes 100, which is marked with an indication of “unavailable”.

The range of drug thicknesses is indicated for each one of the second through holes. Specifically, the range of drug thicknesses is indicated in the vicinity of each second through hole. In the vicinity of second through hole H21 is indicated that the range of drug thicknesses is less than or equal to the width of second through hole H21. In the vicinity of second through hole H22 is indicated that the range of drug thicknesses is greater than or equal to the width of second through hole 1121 and less than or equal to the width of second through hole 122. In the vicinity of second through hole H23 is indicated that the range of drug thicknesses is greater than or equal to the width of second through hole. H22 and less than or equal to the width of second through hole H123. The widths of second through holes 1121 to 1123 are, respectively, 1.8 mm, 2.5 mm, and 3.2 mm.

When drug is fitted into one after another of second through holes H21 to H23 in the order of smaller to larger widths, the drug is determinable as having a thickness within a certain range of dimensions based on the width of one of these through holes which the drug is first permitted to pass through. To be specific, the range of numeral values indicated in the vicinity of second through hole that the drug first passed through may be determined as the range of drug thicknesses. Second through holes H21 to H123 may be used to determine the range of drug thicknesses for the A-type drug shape and drug diameters of 6.01 mm to 7.00 mm.

Similarly, second through holes H31 to H33 are used to determine the range of drug thicknesses for the A-type drug shape with diameters of 7.01 mm to 8.00 mm. Second through holes H41 to H43 are used to determine the range of drug thicknesses for the B-type drug shape with diameters of 6.01 mm to 7.00 mm. Second through holes H51 to H54 are used to determine the range of drug thicknesses for the B-type drug shape with diameters of 7.01 mm to 8.00 mm. Second through holes H61 to 1164 are used to determine the range of drug thicknesses for the B-type drug shape with diameters of 8.01 mm to 9.00 mm.

Cassette selecting tool 400 provides an indication of a relationship of association between the drug dimensions and cassettes 100. To be specific, the model number of drug-suppliable cassette 100 is indicated for each one of the second through holes. A model number “Aa” of cassette 100 is indicated in the vicinity of second through hole 1122. This means that cassette 100 with the model number “Aa” is capable of supplying drugs of the A-type shape, 6.01 mm to 7.00 mm in diameter, and 1.81 mm to 2.50 mm in thickness. Similarly, model numbers “Ab” to “Ad” and “Ba” to “Bh” are indicated. There is no cassette model number in the vicinity of second through holes for drug thicknesses beyond the allowable range of cassettes 100, which is marked with an indication of“unavailable”.

The identification information of each cassette 100 also includes the model number described above. While cassettes 100 typically have cassette numbers that differ from one another, some cassettes 100 may have the same model number. In this embodiment, the model number appended to each cassette 100 is stored in the RFID tag.

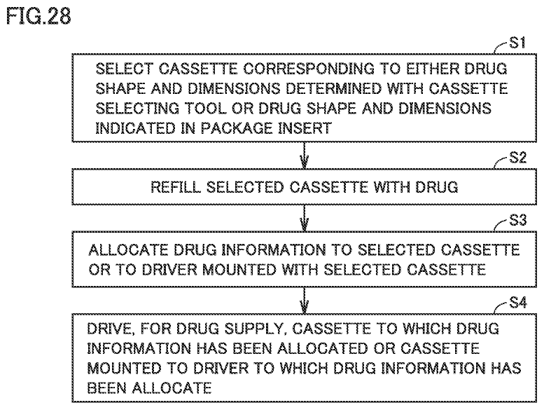

FIG. 28 is a flow chart of operational steps for drug supply from a cassette selected in accordance with dimensions of the drug in the drug supply device according to an embodiment of this invention. At the time of drug supply from the drug supply device according to the embodiment of this invention, first, cassette 100 is selected that is suitable for the drug shape and dimensions determined by cassette selecting tool 400 of FIG. 27, as illustrated in FIG. 28 (step S1). Optionally, an appropriate one of cassettes 100 may be selected based on the indications of cassette selecting tool 400 with reference to drug shapes and dimensions read from the package insert.

Next, cassette 100 thus selected is supplied with drug (step S2). To be specific, cassette 100 with a model number indicated on cassette selecting tool 400 is supplied with drug.

When the drug-supplied cassette 100 is mounted to driver 231, RFID reader/writer 232 reads information from the RFID tag appended to cassette 100 mounted earlier to driver 231, and controller 270 allocates the relevant drug information to this driver 231 (step S3). The drug allocating device according to the embodiment includes cassettes 100, cassette selecting tool 400, and controller 270. Controller 270 may instead allocate the drug information to the drug-supplied cassette 100.

Controller 270 drives cassette 100 mounted to the drug information-allocated driver 231 for drug supply (step S4). Specifically, controller 270 drives driver 231 to supply drug from cassette 100 mounted to the drug information-allocated driver 231. In a case that the drug information has been allocated to cassette 100, controller 270 drives cassette 100 to which the drug information is allocated for drug supply. Specifically, controller 270 drives driver 231 mounted with cassette 100 to which the drug information has been allocated, to supply drug from this cassette 100.

The drug supply device according to an embodiment of this invention includes a plurality of cassettes 100, cassette selecting tool 400, a plurality of drivers 231, and controller 270. Cassettes 100 are each allowed to supply drug within a certain range of dimensions. Cassette selecting tool 400 is capable of selecting, from a plurality of cassettes 100, cassette 100 that can supply drug in accordance with dimensions of the drug. A plurality of drivers 231 are each mountable with each of cassettes 100 and drive cassettes 100 mounted thereto. Controller 270 controls drivers 231 individually. Controller 270 allocates the drug information to cassette 100 selected by cassette selecting tool 400 or to driver 231 mounted with cassette 100 thus selected. Controller 270 controls drivers 231 so that the drug is supplied from cassette 100 to which the drug information has been allocated or from cassette 100 mounted to driver 231 to which the drug information has been allocated.

Thus, a user who operates the drug supply device may readily select drug-suppliable cassette 100.

Cassette selecting tool 400 according to an embodiment of this invention includes an indication of a relationship of association between the drug dimensions and cassettes 100. This may facilitate the selection of cassette 100 suitable for the drug dimensions.

Cassette selecting tool 400 according to an embodiment of this invention includes an indication of a relationship of association among the drug shapes, drug dimensions, and cassettes 100. This may facilitate the selection of cassette 100 suitable for the drug shape and dimensions.

In an embodiment of this invention, the drug dimensions indicated correspondingly to cassette 100 on cassette selecting tool 400 include the drug diameter and drug thickness. This may facilitate the selection of cassette 100 suitable for the drug diameter and thickness.

In an embodiment of this invention, cassette selecting tool 400 has a plurality of through holes each having a circular shape that differ in diameter from each other. When the drug is fitted into one after another of these through holes in the order of smaller to larger diameters, the drug is determinable as having a diameter within a certain range of dimensions based on the diameter of one of the through holes which the drug is first permitted to pass through. Thus, the range of drug diameters may be readily determined.

In an embodiment of this invention, cassette selecting tool 400 has a plurality of through holes each having a rectangular shape that differ in width from each other. When the drug is fitted into one ater another of the through holes in the order of smaller to larger widths, the drug is determinable as having a thickness within a certain range of dimensions based on the width of one of the through holes which the drug is first permitted to pass through. Thus, the range of drug widths may be readily determined.

Cassette selecting tool according to an embodiment of this invention includes an indication of a certain range of drug dimensions for each one of the through holes. Thus, the range of drug dimensions may be readily determined.

The drug allocating device according to the embodiment includes a plurality of cassettes 100, cassette selecting tool 400, and controller 270. Cassettes 100 are each allowed to supply drug within a certain range of dimensions. Cassette selecting tool 400 is capable of selecting, from a plurality of cassettes 100, cassette 100 that can supply drug in accordance with dimensions of the drug. Controller 270 allocates the drug information to cassette 100 selected by cassette selecting tool 400. Thus, a user who operates the drug allocating device may readily select drug-suppliable cassette 100.

### ASPECTS

Those skilled in the art in the relevant technical field should naturally understand that the examples and embodiments described herein include the following aspects.

### First Aspect

A drug supply device according to a first aspect includes:
a plurality of cassettes each capable of supplying drug within a certain range of dimensions,
a cassette selecting tool that is capable of selecting the cassette that can supply the drug in accordance with dimensions of the drug,
a plurality of drivers each mountable with each of the cassettes and driving the cassette mounted thereto; and
a controller that controls the drivers individually,
the controller allocating drug information of the drug to the cassette selected by the cassette selecting tool or to the driver mounted with the cassette thus selected,
the controller controlling the drivers so that the drug is supplied from the cassette to which the drug information has been allocated or from the cassette mounted to the driver to which the drug information has been allocated.

### Second Aspect

in the drug supply device according to the first aspect, the cassette selecting tool includes an indication of a relationship of association between the dimensions of the drug and the cassettes.

### Third Aspect

In the drug supply device according to the first aspect, the cassette selecting tool includes an indication of a relationship of association among the dimensions of the drug, shapes of the drug, and the cassettes.

### Fourth Aspect

In the drug supply device according to the second or third aspect, the dimensions of the drug indicated correspondingly to the cassettes on the cassette selecting tool include a diameter and a thickness of the drug.

### Fifth Aspect

In the drug supply device according to the fourth aspect,
the cassette selecting tool has a plurality of through holes each having a circular shape that differ in diameter from each other, and
when the drug is fitted into one after another of the through holes in the order of smaller to larger diameters, the drug is determinable as having a diameter within a certain range of dimensions based on the diameter of one of the through holes which the drug is first permitted to pass through.

### Sixth Aspect

In the drug supply device according to the fourth aspect,
the cassette selecting tool has a plurality of through holes each having a rectangular shape that differ in width from each other, and
when the drug is fitted into one after another of the through holes in the order of smaller to larger widths, the drug is determinable as having a thickness within a certain range of dimensions based on the width of one of the through holes which the drug is first permitted to pass through.

### Seventh Aspect

in the drug supply device according to the fifth or six aspects, the cassette selecting tool includes an indication of a certain range of dimensions of the drug for each one of the through holes.

### Eighth Aspect

The cassette selecting tool according to one aspect is capable of selecting, from a plurality of cassettes, a cassette that can supply the drug in accordance with dimensions of the drug.

### Ninth Aspect

The cassette selecting tool according to the eighth aspect includes an indication of a relationship of association between dimensions of the drug and the cassettes.

### 10th Aspect

The cassette selecting tool according to the eighth aspect includes an indication of a relationship of association among dimensions of the drug, shapes of the drug, and the cassettes.

### 11th Aspect

In the cassette selecting tool according to the ninth or tenth aspect, the dimensions of the drug indicated correspondingly to the cassettes on the cassette selecting tool include a diameter and a thickness of the drug.

### 12th Aspect

The cassette selecting tool according to the 11th aspect has a plurality of through holes each having a circular shape that differ in diameter from each other, and
when the drug is fitted into one after another of the through holes in the order of smaller to larger diameters, the drug is determinable as having a diameter within a certain range of dimensions based an the diameter of one of the through holes which the drug is first permitted to pass through.

### 13th Aspect

The cassette selecting tool according to the 1th aspect has a plurality of through holes each having a rectangular shape that differ in width from each other, and
when the drug is fitted into one after another of the through holes in the order of smaller to larger widths, the drug is determinable as having a thickness within a certain range of dimensions based on the width of one of the through holes which the drug is first permitted to pass through.

### 14th Aspect

The cassette selecting tool according to the 12th or 13th aspect includes an indication of a certain range of dimensions of the drug for each one of the through holes.

### 15th Aspect

A drug allocating device according to one aspect includes
a plurality of cassettes each allowed to supply drug within a certain range of dimensions,
a cassette selecting tool allowed to select the cassette that can supply the drug in accordance with dimensions of the drug; and
a controller that allocates drug information of the drug to the cassette selected by the cassette selecting tool.

The embodiments disclosed herein are illustrated by way of example in all aspects and should not support any narrow interpretation of this invention. The technical scope of this invention should not be construed on the basis of the embodiments described herein and should be solely defined by the appended claims. The scope of this invention encompasses all of modifications within the scopes of claims and equivalence.

### REFERENCE SIGNS LIST

100: cassette, 110: drug container, 111: circumferential wall, 111a: partial circumferential wall, 112: outlet, 113: opening, 120: rotor, 121: circumferential surface, 122: first protrusion, 123: second protrusion, 124: third protrusion, 125, L: interval, 126: top surface, 127, groove, 128: central protrusion, 128c: recess, 129, 152c: cutout, 130: cover, 140: partitioning portion, 141: substrate, 150: drive shaft, 151: magnetic body, 152: edge, 152h: through hole, 153: spring pin, 160: cap member, 161: magnet, 162: supporter, 163: cap, 164: spacer, 200: drug split-packaging apparatus, 210: cabinet, 220: tablet supplier, 230: cassette position, 231: driver, 232 reader/writer, 240: manual drug supply cassette, 250: powdered drug supplier, 260: packaging device, 270, 340: controller, 271, 341: storage, 300: control device, 310, operating portion, 320: displayer, 330: reader, 400: cassette selecting tool, G: passage, P1: prescription screen, P2: selection screen, P3: refill instructing screen, P4: manual supply instructing screen. P5: cassette use history screen, R1, R2, T28: selected region, RD: compartment region, T1, T11, T21, T31: prescription information field, T2: operation status field, T3, T32: packaged pouch number field, T4: display-start input field, T5: packaging-start input field, T6: operation-stop input field, T12, T33: manual supply list field, T13, T34: tablet number field, T14: region selection field, T15, T44: cassette position field, T16: specified drug field, T17: cassette record field, T18: allocated drug information field, T19a, T29a, T39a, T47: first switchover input field, T19b, T29b, T48: second switchover input field, T19c, T29c, T39b, T49: third switchover input field, T22: refill drug information field, T23: refill cassette position field, T25: identification mark, T27: attention field, T35: compartment region field, T41: search condition field, T42: dispensing date/time field, T43: cassette identification information field, T45: drug information field, T46: patient field, T51: drug shape field, T52: drug diameter field, T53: drug thickness field.

1. A drug supply device comprising:
a plurality of cassettes each capable of supplying drug within a certain range of dimensions;
a plurality of drivers each mountable with each of the cassettes and driving the cassette mounted thereto; and
a controller that controls the drivers individually,
the controller allocating drug information of a target drug to the cassette selected in accordance with dimensions of the target drug or to the driver mounted with the cassette thus selected,
the controller controlling the drivers so that the target drug is supplied from the cassette to which the drug information has been allocated or from the cassette mounted to the driver to which the drug information has been allocated.

2. The drug supply device according to claim 1, further comprising a manual drug supply cassette,
wherein the controller is capable of accepting an operation that is input for selecting which of the cassette and the manual drug supply cassette supplies the target drug.

3. The drug supply device according to claim 2, wherein the controller does not accept an operation that is input for selecting drug supply from the cassettes in an event that none of the drivers is mountable with the cassettes.

4. The drug supply device according to claim 2, wherein the controller does not accept the operation that is input for supply, from the cassette, of the drug that can be supplied from none of the cassettes.

5. The drug supply device according to claim 1, further comprising a displayer that is capable of displaying information concerning allocation of the drug information.

6. The drug supply device according to claim 5, wherein the controller causes the displayer to display the driver to which the cassette is mountable and the driver to which the cassette is not mountable in a distinguishable manner.

7. The drug supply device according to claim 5, wherein the controller causes the displayer to display the drug that can be supplied from the cassette and the drug that cannot be supplied from the cassette in a distinguishable manner.

8. The drug supply device according to claim 5, wherein the controller causes the displayer to display a history of use of the cassettes.

9. The drug supply device according to claim 5, wherein the controller causes the displayer to display identification information of the cassette that most recently supplied the target drug.

10. The drug supply device according to claim 5, wherein the controller causes the displayer to display a required number of tablets of the target drug for refill.

11. The drug supply device according to claim 5, wherein the controller causes the displayer to display a shortfall of the target drug in an event of shortage of the target drug.

12. The drug supply device according to claim 1, further comprising a reader that reads an identification code appended to a drug holder of the target drug, wherein
the controller checks the drug information against a result read and obtained by the reader.

13. The drug supply device according to claim 1, wherein the controller allocates the drug information to the driver when the cassette selected in accordance with the dimensions of the target drug is mounted to the driver.

14. A drug supply device, comprising:
a plurality of drug suppliers each capable of supplying drug within a certain range of dimensions; and
a controller,
wherein
the controller allocating drug information of a target drug to the drug supplier selected in accordance with dimensions of the target drug,
the controller controlling the drug suppliers so that the target drug is supplied from the drug supplier to which the drug information has been allocated.
